(19) United States
(12) Patent Application Publication
(10) Pub. No.: US 2018/0172266 A1
(43) Pub. Date: Jun. 21, 2018

(54) ELECTRIC RESISTANCE HEATER SYSTEM AND LIGHT TOWER

(71) Applicant: Electric Horsepower Inc., Nisku (CA)

(72) Inventors: Robert FOLK, Edmonton (CA); Adrian LACHANCE, Red Deer (CA)

(73) Assignee: Electric Horsepower Inc., Nisku (CA)

(21) Appl. No.: 15/387,377

(22) Filed: Dec. 21, 2016

(51) Int. Cl. F21V 33/00; F24H 3/04; F24H 9/20; F21L 13/00; F21V 21/26

(52) U.S. Cl. CPC F21V 33/0092; F24H 3/0417; F24H 9/2071; F21Y 2115/10; F21V 21/26; F21V 33/0052; F21L 13/00

(57) ABSTRACT

A portable heater system including a pressurized air source, adapted to convey ambient air through an electric resistance heater, to provide heated breathable air, and a controller adapted to control the electric resistance heater and the pressurized air source. A generator, driven by an internal combustion engine may be provided to power the electric resistance heater and the pressurized air source. The portable heater system may be embodied in a light tower.

### FIELD

The present disclosure relates generally to heating and work-site illumination. More particularly, the present disclosure relates to portable electric resistance heating and portable lighting.

### BACKGROUND

Portable light towers are used for temporarily lighting an area, for example a work-site. They typically include an engine driven generator and one or more lights.

However, in colder climates, there is also need for heating and lighting.

It is, therefore, desirable to provide an electric resistance heater system and light tower, as such a system can provide heat, light, and electricity generation.

### SUMMARY

It is an object of the present disclosure to obviate or mitigate at least one disadvantage of previous electric resistance heater systems and light towers.

In a first aspect, the present disclosure provides a portable heater system including a pressurized air source, adapted to convey ambient air through an electric resistance heater, to provide heated breathable air, and a controller adapted to control the electric resistance heater and the pressurized air source.

In an embodiment disclosed, the heater includes an expansive plenum housing a plurality of heating elements, wherein air velocity is reduced through the plenum to provide increased contact time with the plurality of heating elements.

In an embodiment disclosed, the plenum includes a tortuous heat path across the plurality of heating elements, to provide increased contact time and to provide an increase in the eddy currents/turbulent flow to improve heat transfer to the air.

In an embodiment disclosed, the plurality of heating elements are set in a densely packed configuration.

In an embodiment disclosed, the plenum includes an obstructed heat path, the plurality of heating elements forming obstructions, to provide increased contact time and to provide an increase in the eddy currents/turbulent flow to improve heat transfer to the air.

In an embodiment disclosed, the plurality of heating elements are provided in several successive/sequential rows, to provide multiple stages of heating.

In an embodiment disclosed, an outlet flow path, from the plurality of heating elements to an outlet is smooth or direct to minimize pressure loss.

In an embodiment disclosed, the system further includes a generator, driven by an internal combustion engine, the generator adapted to power the electric resistance heater and the pressurized air source.

In an embodiment disclosed, the system further includes an exhaust heat recovery unit, to pre-heat the ambient air using exhaust heat from the internal combustion engine.

In an embodiment disclosed, the exhaust heat recovery unit comprises a heat exchanger, with exhaust on the hot side and the ambient air on the cold side.

In an embodiment disclosed, the coolant heat recovery unit comprises a radiator.

In an embodiment disclosed, the system further includes an active louver system, including a plurality of shutters selectively moveable between an open positon where ambient airflow is generally unrestricted through the plurality of shutters and a closed position where ambient airflow is generally restricted through the plurality of shutters.

In an embodiment disclosed, the system further includes a coolant heat recovery unit, to pre-heat the ambient air using coolant heat from the internal combustion engine.

In an embodiment disclosed, the coolant heat recovery unit comprises a heat exchanger, with engine coolant on the hot side and the ambient air on the cold side.

In an embodiment disclosed, the system further includes an enclosure, substantially enclosing at least the internal combustion engine; and an enclosure heat recovery unit, to pre-heat the ambient air using heat from the enclosure.

In an embodiment disclosed, the system further includes an exhaust heat recovery unit, to heat the heated breathable air using exhaust heat from the internal combustion engine, to further heat the heated breathable air.

In an embodiment disclosed, the exhaust heat recovery unit is a heat exchanger, with exhaust on the hot side and the heated breathable air on the cold side.

In an embodiment disclosed, the plurality of heating elements are 3-phase, and are wired in a selected wiring configuration.

In an embodiment disclosed, the selected wiring configuration is a delta or a Wye or a Star or in series or in series parallel.

In an embodiment disclosed, the selected wiring configuration is a delta configuration for the heating elements proximate an inlet end of the plenum.

In an embodiment disclosed, the selected wiring configuration is a wye configuration for the heating elements proximate an outlet end of the plenum.

In an embodiment disclosed, the selected wiring configuration is a delta configuration for the heating elements proximate an inlet end of the plenum, and wherein the selected wiring configuration is a wye configuration for the heating elements proximate an outlet end of the plenum.

In an embodiment disclosed, the pressurized air source is selected from the group consisting of an air blower, an air compressor, and a fan.

In an embodiment disclosed, the pressurized air source is an air compressor, wherein the air compressor is adapted to compress the air to pre-heat the ambient air.

In an embodiment disclosed, the controller includes contact switching to control the plurality of heating elements.

In an embodiment disclosed, the controller includes silicon controlled rectifier (SCR) switching or insulated-gate bipolar transistor (IGBT) switching to control the plurality of heating elements.

In an embodiment disclosed, the system further includes an electronics heat recovery unit, to pre-heat the ambient air using heat from one or more of the controller, IGBT switching, SCR switching, and pressurized air source drive.

In an embodiment disclosed, the electronics heat recovery unit comprises a ducting on enclosure adapted to route at least a portion of the ambient air through the electronics heat recovery unit.

In an embodiment disclosed, the system further includes a hose or conduit between the plenum and a heat user, for supplying the heated breathable air to the heat user.

In an embodiment disclosed, the hose or conduit is a heated hose or conduit.

In an embodiment disclosed, the heated hose or conduit is electrically traced or electrically heated or both.

In an embodiment disclosed, the system further includes a hot air wand, the hose or conduit adapted to supply the heated breathable air to the hot air wand.

In an embodiment disclosed, the heat user comprises a hot air distributor, wherein the hose or conduit is adapted to supply the heated breathable air to the hot air distributor to heat an enclosed space or building.

In an embodiment disclosed, the system further includes a utility power source connection, adapted to connect to a utility powerline supply to power the electric resistance heater, the pressurized air source, the controller, or combinations thereof.

In an embodiment disclosed, the utility power is shore power.

In an embodiment disclosed, the system further includes a communication system adapted to provide an electronic telecommunications link between the communication system and a mobile computing device for remote reporting, remote monitoring, remote control or combinations thereof, the electronic telecommunications link comprising one or more of Wi-Fi, Bluetooth, cellular, internet, satellite, and microwave.

In an embodiment disclosed, the system further includes a surveillance system, the surveillance system including a camera system adapted to capture still images, video, or both, and a memory to store the captured images or video.

In an embodiment disclosed, the system further includes a communication system adapted to provide an electronic telecommunications link between the communication system and a mobile computing device for remote reporting, remote monitoring, remote control or combinations thereof, the electronic telecommunications link comprising one or more of Wi-Fi, Bluetooth, cellular, internet, satellite, and microwave, and a processor for sending the captured images or video to the mobile computing device via the communications system, wherein the remote reporting or remote monitoring comprises transmitting still images, video, or both periodically, live, real-time, near real time, or upon a triggering event.

In an embodiment disclosed, the system further includes a wireless receiver adapted to receive a temperature signal from a wireless temperature remote system to control the temperature proximate the wireless temperature remote system.

In an embodiment disclosed, the system further includes a recirculated air inlet upstream of the electric resistance heater, adapted to receive recirculated air from a heated building or enclosure or from the heated breathable air or both.

In a further aspect, the present disclosure provides, a portable light tower, including a mobile base, the portable heater system described herein, a mast, movable between an operating position and a transport position, and one or more lights mounted on the mast, the generator further adapted to power the one or more lights.

In an embodiment disclosed, the mast is secured to the mobile base.

In an embodiment disclosed, the mobile base comprises a wheeled trailer, a tractor trailer, a skid, a module, or a shipping container.

In an embodiment disclosed, the portable light tower further comprises a camera system mounted on the mast, the camera system adapted to capture still images, video, or both.

In an embodiment disclosed, the portable light tower further includes a communication system adapted to provide an electronic telecommunications link between the communications system and a mobile computing device for remote reporting, remote monitoring, remote control or combinations thereof, the electronic telecommunications link comprising one or more of Wi-Fi, Bluetooth, cellular, internet, satellite, and microwave.

In an embodiment disclosed, the portable light tower further includes a surveillance system, the surveillance system including a camera system adapted to capture still images, video, or both, and a memory to store the captured images or video.

In an embodiment disclosed, the portable light tower further includes a communication system adapted to provide an electronic telecommunications link between the communication system and a mobile computing device for remote reporting, remote monitoring, remote control or combinations thereof, the electronic telecommunications link comprising one or more of Wi-Fi, Bluetooth, cellular, internet, satellite, and microwave, and a processor for sending the captured images or video to the mobile computing device via the communications system, wherein the remote reporting or remote monitoring comprises transmitting still images, video, or both periodically, live, real-time, near real time, or upon a triggering event.

In an embodiment disclosed, the portable light tower further includes a wireless receiver adapted to receive a temperature signal from a wireless temperature remote system to control the temperature proximate the wireless temperature remote system.

In an embodiment disclosed, the generator comprises a multi-voltage genset and transformers to provide between two and four different voltages at one time.

In an embodiment disclosed, the portable light tower further includes a recirculated air inlet, upstream of the electric resistance heater, adapted to receive recirculated air from a heated building or enclosure or from the heated breathable air or both.

In an embodiment disclosed, the one or more lights include light emitting diode (LED) lights.

In an embodiment disclosed, the LED lights operate on 208 volts or 230 volts.

In a further aspect, the present disclosure provides a portable heater system for a light tower having a generator driven by an internal combustion engine, including a pressurized air source, adapted to convey ambient air through the electric resistance heater, to provide heated breathable air, a power coupling, adapted to connect the electric resistance heater to the generator, wherein the generator is adapted to power the electric resistance heater and the pressurized air source, and a controller adapted to control the electric resistance heater and the pressurized air source.

In an embodiment disclosed, the portable heater system includes an exhaust heat recovery unit, adapted to pre-heat the ambient air using exhaust heat from the internal combustion engine, and an engine exhaust coupling, adapted to connect the exhaust heat recovery unit to the internal combustion engine.

In an embodiment disclosed, the portable heater system includes a coolant heat recovery unit, adapted to pre-heat the ambient air using coolant heat from the internal combustion engine, and an engine coolant coupling, adapted to connect the coolant heat recovery unit to the internal combustion engine.

In an embodiment disclosed, the portable heater system comprises an enclosure substantially enclosing at least the internal combustion engine, the portable heater system further including an enclosure heat recovery unit, adapted to pre-heat the ambient air using heat from the enclosure envelope, and an enclosure coupling, adapted to connect the enclosure heat recovery unit to the enclosure.

In an embodiment disclosed, the portable heater system comprising an electronics heat recovery unit, to pre-heat the ambient air using heat from one or more of the controller, IGBT switching, SCR switching, and blower motor.

In an embodiment disclosed, the electronics heat recovery unit comprises a ducting on enclosure adapted to route at least a portion of the ambient air through the electronics heat recovery unit.

In an embodiment disclosed, the portable heater system further includes a recirculated air inlet, upstream of the electric resistance heater, adapted to receive recirculated air from a heated building or enclosure or from the heated breathable air or both.

In a further aspect, the present disclosure provides a method of operating the portable heater system described herein, the portable light tower described herein, or the portable heater system for a light tower as described herein, including setting a mode of operation, the mode of operation selected from the group of a normal mode of operation, and controlling the electric resistance heater and the pressurized air source in response to a local user selectable setting for the electric resistance heater or the pressurized air source or both, and a stand-by or shut down for night (SDFN) mode of operation, and controlling the electric heater and the pressurized air source in a stand-by mode.

In an embodiment disclosed, the group further includes an adaptive mode of operation, and controlling the electric heater and the pressurized air source to automatically phase back the electric heater to make power available to an auxiliary load when the auxiliary load is added, and ramp up the electric heater when the auxiliary load is removed.

In an embodiment disclosed, the auxiliary load comprises a well site shack or other electrical load.

In an embodiment disclosed, the group further includes a one hundred degree plus rise mode of operation, and controlling the electric heater and the pressurized air source to automatically provide a temperature rise of about 100° F. plus, a safety mode of operation, and controlling the electric heater and the pressurized air source to automatically limit the heated air temperature to a maximum of about 212° F., a no burn mode of operation, and controlling the electric heater and the pressurized air source to automatically limit the heated air temperature to a maximum of about 220° F., a hazardous location mode of operation, and controlling the electric heater and the pressurized air source to automatically limit the heated air temperature to a maximum of about 392° F., and a high heat mode of operation, and controlling the electric heater and the pressurized air source to automatically limit the heated air temperature to a maximum of about 1000° F., a maximum heat mode of operation, and controlling the electric heater and the pressurized air source to automatically limit the heated air to a maximum of about 1600° F.

In an embodiment disclosed, in the hazardous location mode of operation, the maximum heated air temperature reduced to take into account the heat soak of the electric heater, such that even in the event of the loss of the pressurized air source, the temperature would not exceed 392° F.

In an embodiment disclosed, the group further comprising a remote mode of operation, and controlling the electric heater and the pressurized air source in response to a remote user setting for the electric heater or the pressurized air source or both.

In an embodiment disclosed, the remote user setting is provided via an electronic telecommunications link, adapted to provide for remote monitoring, remote reporting, remote control or combinations thereof, the electronic telecommunications link comprising one or more of Wi-Fi, Bluetooth, cellular, internet, microwave and satellite.

In an embodiment disclosed, the method further includes providing a wireless temperature remote system and an associated receiver, adapted to measure the temperature at a remote location which is received at the receiver; and the group further includes a remote set temperature mode, wherein the electric heater and the pressurized air source are operated to maintain the temperature at the remote location.

In an embodiment disclosed, the method further includes directing the heated breathable air to an at least partially enclosed space or building.

In an embodiment disclosed, the at least partially enclosed space or building is a high rise building while under construction.

In an embodiment disclosed, the method further includes tying the portable heater system or the portable light tower into building duct work.

In an embodiment disclosed, the method further includes recirculating at least a portion of the air from the at least partially enclosed space or building to the electric resistance heater.

In an embodiment disclosed, the at least partially enclosed space or building is a wellhead enclosure.

In an embodiment disclosed, the at least partially enclosed space or building is an environmentally controlled workspace.

In an embodiment disclosed, the method further includes conducting a workspace activity once the environmentally controlled workspace reaches a predetermined temperature.

In an embodiment disclosed, the workspace activity is maintaining at least the predetermined temperature to allow stucco or concrete to cure.

In an embodiment disclosed, the at least partially enclosed space or building is the interior of a segment of pipeline.

In an embodiment disclosed, the method further includes conducting a pipeline activity once the segment of pipeline reaches a predetermined temperature.

In an embodiment disclosed, the pipeline activity is selected from the group of warming, drying, sandblasting, coating/painting, fabrication, bending, welding, moving, and expansion or growth testing.

In an embodiment disclosed, the at least partially enclosed space or building is the interior of a storage or process tank or vessel.

In an embodiment disclosed, the method further includes conducting a tank or vessel activity once the tank or vessel reaches a predetermined temperature.

In an embodiment disclosed, the tank or vessel activity selected from the group of warming, drying, sandblasting, coating/painting, bending, and welding.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a simplified schematic of a portable heater system of the present disclosure, showing an air flow path.

FIG. 1A is a simplified schematic of a portable heater system of the present disclosure, showing an air flow path and an active louver system.

FIG. 2 is an isometric view of an electric resistance heater of the present disclosure.

FIG. 3 is a front side view of the electric resistance heater of FIG. 2.

FIG. 4 is a top view of the electric resistance heater of FIG. 2.

FIG. 5 is a front side section view of the electric resistance heater of FIG. 2 along section H-H of FIG. 4.

FIG. 6 is a right side view of the electric resistance heater of FIG. 2.

FIG. 7 is a back side view of the electric resistance heater of FIG. 2.

FIG. 8 is a front side view of the electric resistance heater of FIG. 2.

FIG. 9 is a side section view of the electric resistance heater of FIG. 2 along section A-A of FIG. 8.

FIG. 9A is a detail of FIG. 9.

FIG. 10 is a side section view of the electric resistance heater of FIG. 2 along section B-B of FIG. 8.

FIG. 11 is a side section view of the electric resistance heater of FIG. 2 along section C-C of FIG. 8.

FIG. 11A is a detail of FIG. 11.

FIG. 12 is an isometric view of a light tower of the present disclosure.

FIG. 13 is a back side view of the light tower of FIG. 12.

FIG. 14 is a right side view of the light tower of FIG. 12.

FIG. 15 is an isometric view of a light tower of the present disclosure.

FIG. 16 is a side view of the light tower of FIG. 15.

FIG. 17 is an isometric view of a light tower of the present disclosure.

FIG. 18 is a side view of the light tower of FIG. 17.

FIG. 19 is a back side view of the light tower of FIG. 17.

FIG. 20 is an isometric view of a light tower of the present disclosure.

FIG. 21 is a side view of the light tower of FIG. 20.

FIG. 22 is an an isometric view of a light tower of the present disclosure.

FIG. 23 is a side view of the light tower of FIG. 22.

FIG. 24 is a simplified schematic of an electric resistance heater of the present disclosure in use with a building or structure.

FIG. 25 is a simplified schematic of an electric resistance heater of the present disclosure in use with a pipeline.

FIG. 26 is a simplified schematic of an electric resistance heater of the present disclosure in use with a tank or vessel.

FIG. 27 is a simplified schematic of an electric resistance heater of the present disclosure in use with a building or enclosure.

FIG. 28 is a simplified plan view of the use of FIG. 27.

### DETAILED DESCRIPTION

Generally, the present disclosure provides a method and system for heating an enclosed space or building or lighting an area or both.

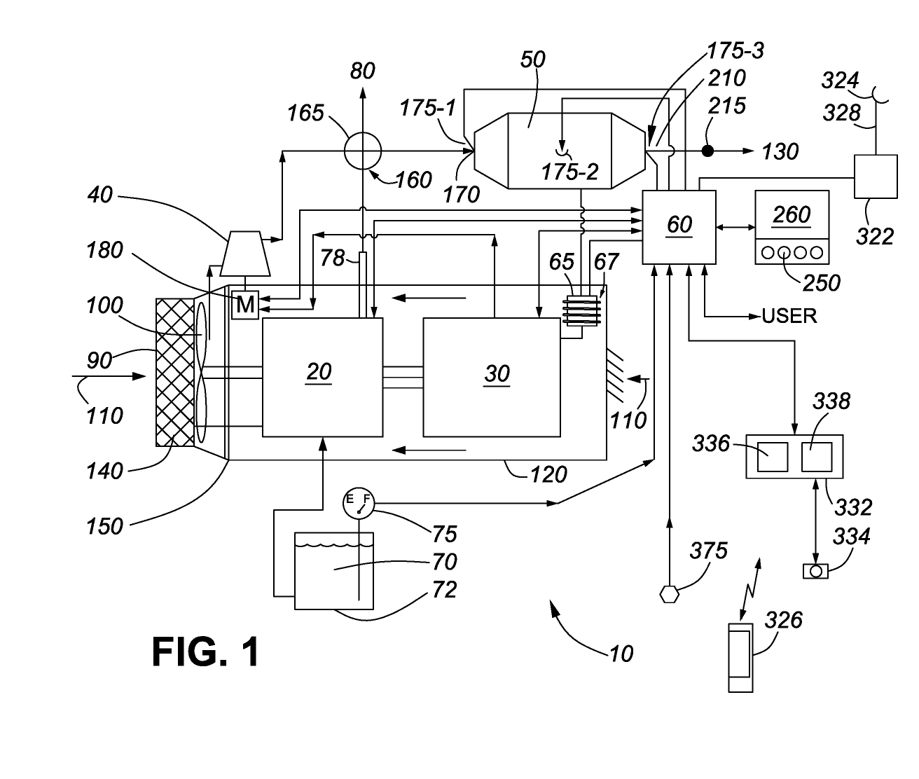

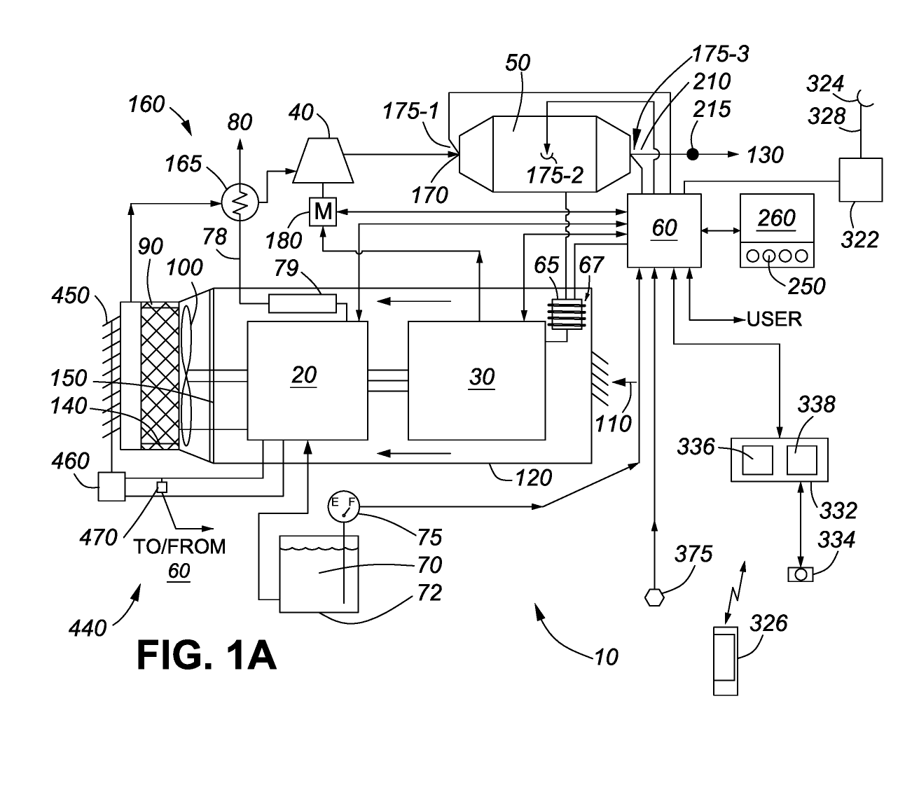

Referring to FIG. 1, the disclosed portable heater system 10 includes an engine 20 (typically an internal combustion engine), a generator 30, a pressurized air source 40, an electric resistance heater 50, and a controller 60 for controlling the electric resistance heater 50 and the pressurized air source 40. The engine 20 drives the generator 30, and electricity from the generator 30 powers the electric resistance heater 50, the pressurized air source 40, and the controller 60.

As the engine 20 operates, fuel 70 from fuel tank or tanks 72 is burned and hot gaseous exhaust 80 is created, and the engine 20 is cooled by engine coolant which circulates though a radiator 90. A fan 100 may be used to increase flow of ambient air 110 through the radiator 90. The fuel level 75 in the fuel tank or tanks 72 is provided to the controller 60. The fuel 70 may be, for example, gasoline or diesel, but could also be natural gas or propane or produced gas (e.g. from a well at a wellsite).

One or more of the engine 20, generator 30, pressurized air source 40, electric resistance heater 50, or controller 60 may be housed in an enclosure 120. The enclosure 120 may contain/capture heat or sound or both.

Ambient air 110 is conveyed through the electric resistance heater 50 to provide heated breathable air 130. An air inlet temperature 175-1 (at or near inlet 170), an air outlet temperature 175-3 (at or near outlet 210) and an intermediate air temperature 175-2 (generally proximate the middle of the electric resistance heater 50) are provided to the controller 60.

The ambient air 110 may be pre-heated using heat created by the portable heater system 10. Ambient air 110 may be drawn through a coolant heat recovery unit 140 (e.g. radiator 90) or an enclosure heat recovery unit 150 (e.g. enclosure 120) or both, which provides at least some level of pre-heat to the air. In the coolant heat recovery unit 140, hot coolant from the engine 20 pre-heats the ambient air 110 via radiator 90. In the enclosure heat recovery unit 150, heat from within the enclosure 120 (e.g. heat from the engine 20, generator 30, and if applicable and within the enclosure, also the control box 65 and motor 180) pre-heats the ambient air 110. Further, the ambient air 110 may be conveyed through an exhaust heat recovery unit 160, which provides some level of pre-heat. In the exhaust heat recovery unit 160, heat from the hot gaseous exhaust 80 from the engine 20 pre-heats the ambient air 110. It is important to note that the hot gaseous exhaust 80 and the ambient air 110 do not mix. The exhaust heat recovery unit 160 may include, for example, a heat exchanger 165 which allows at least a portion of the heat from the hot gaseous exhaust 80 to pre-heat the ambient air 110. The exhaust heat recovery unit 160 may include, for example flowing at least a portion of the ambient air 110 over exhaust piping 78 or a muffler 79 of the engine 20.

While shown with the optional coolant heat recovery unit 140, enclosure heat recovery unit 150, and exhaust heat recovery unit 160, each of these is optional (but do increase the efficiency of the portable heater system 10). In an embodiment disclosed, the ambient air 110 is pre-heated to about 185° F. at the inlet 170 of the electric resistance heater 50.

The generator 30 may provide, for example, electricity at between about 110V and about 20000V, for example at one or more of 110V, 208V, 220V, 230V, 240V, 380V, 480V, 575V, 600V, 4160V, or 13800V and at a current rating sufficient to drive the electric resistance heater 50 and the pressurized air source 40. The generator 30 may be sized to provide excess power to run other electrical equipment, such as a well site shack/building, power tools (e.g. drills etc.), pumps, fans, lighting etc. The generator 30 may provide power at multiple voltages, for example two or more of 110V, 208V, 220V, 230V, 240V, 380V, 480V, 575V, 600V, 4160V or 13800V. The internal combustion engine 20 and electricity generator 30 may be referred to as a generator set or “Genset”. The portable heater system 10 includes the typical switchgear, for example electrical disconnects, step up or step down transformers, switches, fuses, and circuit breakers. In an embodiment disclosed, the generator or genset may include tranformers to provide a minimum of four different voltages at one time, for example a 600 volt generator and step down transformers to 480 volt, 230 volt, and 110 volt. The heating elements or coils 230 may operate on any voltage, but auxiliary equipment like the electric motor 180 for the blower 40 and standard power tools or other standard electricity users require a certain voltage or a relatively narrow voltage range in order to operate. The generator 30 can be an induction type, or switch reluctance (SR) type or permanent magnet type. The generator 30 may be DC or AC. The generator 30 may be a variable speed generator. An inverter, power conditioning, transformer, variable speed drive, or other electronics may be used to convert/provide power at the voltages or frequencies required. The generator 30 may operate at between about 1000 and 2400 rpm, depending on the size of engine, the type of engine, and the load. This allows optimum operation for the electrical load and the engine, which lowers emissions, lowers maintenance, and increases fuel economy.

The electric resistance heater 50 may be sized, for example, between about 5 amps and thousands of amps. In an embodiment disclosed, the electric resistance heater 50 may be sized for about 5 amps, 10 amps, 20 amps, 30 amps, 60 amps, 100 amps, 150 amps, 200 amps or higher as required. The electric resistance heater 50 may be single phase or 3-phase.

The pressurized air source may be, for example, a blower 40 or a fan or a compressor driven by a drive, such as an electric motor 180. The electric motor 180 may be, for example, an induction motor or a permanent magnet motor or switched reluctance (SR) motor. Depending on the type of electric motor 180, it may be single speed, multi-speed, or variable speed drive. If the pressurized air source is a compressor, the compressor may be a screw compressor or other compressor. If the pressurized air source is a blower 40, the blower 40 may be a centrifugal blower or other blower. The blower 40 may be a pressure blower or a backward curve or a forward curve blower or a multi-stage blower or compressor. The pressurized air source (e.g. compressor or blower 40) may be configured to generate increased heating of the air, for example by using an inefficient design or an oversized or undersized design, which may be referred to as “blower heating”. The blower may provide a minimum of about 8″ water column of pressure. The blower may provide a minimum of about 27.7″ water column (1 psi) pressure. The electric motor 180 may draw less than about 2 A of current. In an embodiment disclosed, the pressurized air source 40 may provide between about ⅓ psi and about 20 psi air pressure. However, in another embodiment, the pressurized air source 40 may provide an air flow of between about 50 CFM to thousands of CFM and a pressure of between about 20 psi to 250 psi or higher. In an embodiment disclosed, electric resistance heaters 50 of less than about 30 amps may use a pressurized air source 40 of about ⅓ psi. In an embodiment disclosed, electric resistance heaters 50 of about 30 amps and greater may use a pressurized air source 40 of about 1 psi. In an embodiment disclosed, the blower may generate a sound level less than about 70 or 80 dBA when the blower/fan is at full speed, or lower as requested by the customer.

The pressurized air source 40 may include, for example, the fan 100 associated with the radiator 90 (i.e. the fan 100 pulling or pushing ambient air 110 through the radiator 90 of the engine 20). A high performance fan may be used that has a high pitch angle that puts out more air volume and more static pressure than a normal fan blade with the engine 20 driving the generator 30. In embodiments disclosed, the air volume and pressure supplied by the high performance fan may be sufficient, such that a separate pressurized air source 40 (i.e. a dedicated compressor or blower is not required).

In situations where the ambient air 110 is very cold, or where exceptionally hot heated breathable air 130 is required, one or more additional stages of heating may be provided. That is, a further electric resistance heater 50 may be provided in series, and the heated breathable air 130 from the outlet 210 of the electric resistance heater 50 (first stage) is delivered to the inlet 170 of another electric resistance heater 50 (second stage) to increase the temperature rise between the ambient air 110 and the ultimate outlet 210 of the final electric resistance heater 50. A further blower 40 may also be provided.

In an embodiment disclosed, a refrigeration unit may be provided to cool the ambient air 110, rather than heat it or the option to heat or cool may be provided. Rather than heated breathable air 130, the system may provide cooled breathable air or conditioned breathable air. The refrigeration unit may be, for example, a simple vapor compression refrigeration cycle. Ambient air 110 is directed through an evaporator by the blower 40. The evaporator may be positioned, for example, where the electric resistance heater 50 is shown (i.e. cooling instead of heating), or may be upstream or downstream from the electric resistance heater 50 (i.e. in addition to the electric resistance heater 50 to provide selectable option of cooling or heating, dependent on the need and/or ambient temperature). The evaporated refrigerant vapor is conveyed through a compressor and condensed in a condenser to reject the heat outside of the air flow path. The liquid refrigerant expands through an expansion device, such as an expansion valve, and the liquid/vapor refrigerant directed to the evaporator, completing the refrigeration cycle. Where heating is described herein, cooling may be needed/substituted in certain environmental conditions. The refrigeration unit may be removable from the portable heater system 10/portable light tower 320.

Referring to FIG. 1A, in order to improve cold weather performance while permitting warm weather operation, an active louver system 440 may be mounted in front of the radiator 90 to selectively restrict the air flow. A plurality of shutters 450 are movable between a closed position (air flow is restricted) and an open position (air flow is substantially unrestricted—as shown in FIG. 1A). The plurality of shutters 450 may be movable by a hydraulic actuator 460. The hydraulic actuator 460 may be a double acting cylinder (oil pressure opens and oil pressure closes), or may be a single acting spring return cylinder, where a spring closes and oil pressure opens). The hydraulic actuator 460 is responsive to the oil pressure from the engine 20. Oil pressure from the engine 20 opens the shutters 450 (normal state) or selectively actuates the hydraulic actuator 460 to close the shutters 450. An electric solenoid valve 470 (normally open) is provided in the oil line to the hydraulic actuator 460. When the solenoid valve 470 is activated, pressure/flow of oil to the hydraulic actuator 460 is shut off and oil from the hydraulic actuator 460 drained back to the oil sump of engine 20. The spring return of the hydraulic actuator 460 would move the shutters 450 into the open position. In normal operation, the shutters 450 are in the open position, i.e. if the electric resistance heater 50 is not active, the shutters 450 are in the open position. However, subject to override, when the heater 50 is energized, the controller 60, for example a programmable logic controller (PLC), may power the solenoid valve 470, to move the shutters 450 into the closed position to increase pre-heat of the air to the electric resistance heater 50. With the shutters 450 in the closed position, ambient air 110 is pre-heated as it is pulled by the blower 40 through the enclosure 120, over the control box 65 (with IGBT or SCR) and over the engine 20 and over the exhaust piping 80 and through the radiator 90. With the shutters 450 in the closed position, rather than exit the enclosure through the shutters 450, the pre-heated air instead continues through the heat exchanger 165 of the exhaust heat recovery unit 160 and on to the electric resistance heater 50. In FIG. 1A, the ambient air 110 is flowing right to left, including at/through the radiator 90.

If the engine 20 gets too hot (e.g. engine coolant temperature or oil temperature), the controller 60 would re-open the shutters 450 by deactivating the solenoid valve 470. Upon loss of oil pressure to the hydraulic actuator 460 (e.g. mechanical failure or other loss of oil pressure from the engine 20), the shutters 450 are moved into the open position by the spring return of the hydraulic actuator 460.

When the electric resistance heater 50 is de-energized, the shutters 450 are opened.

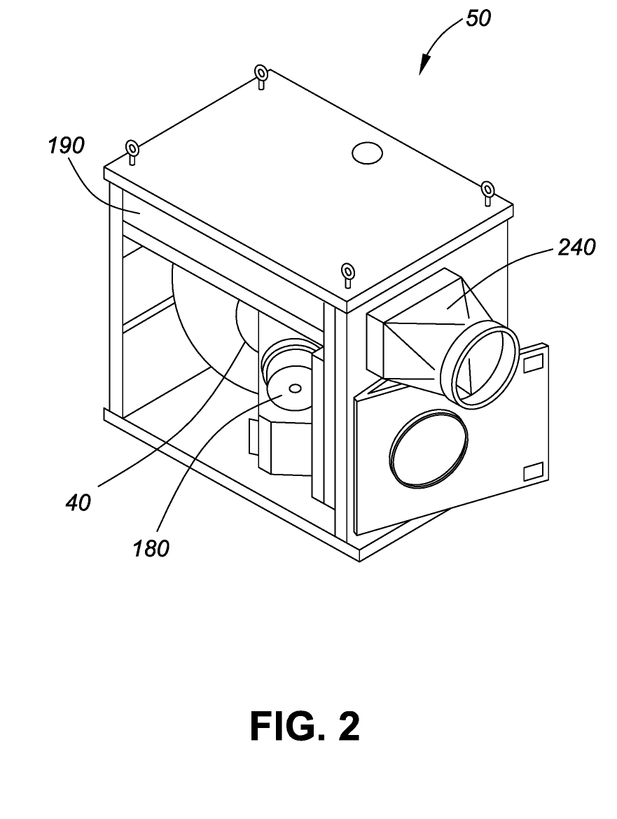

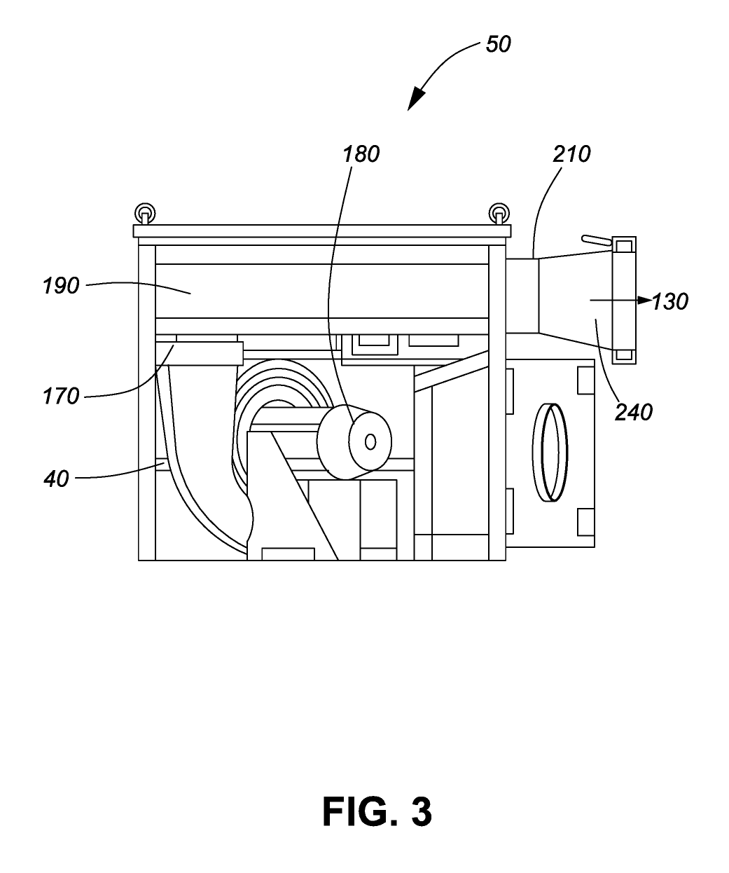

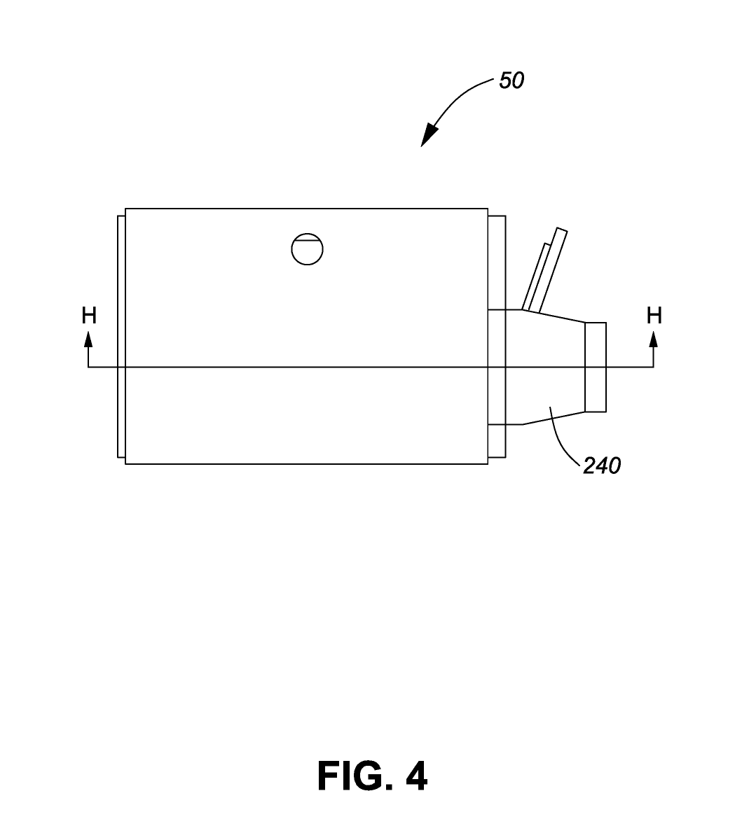

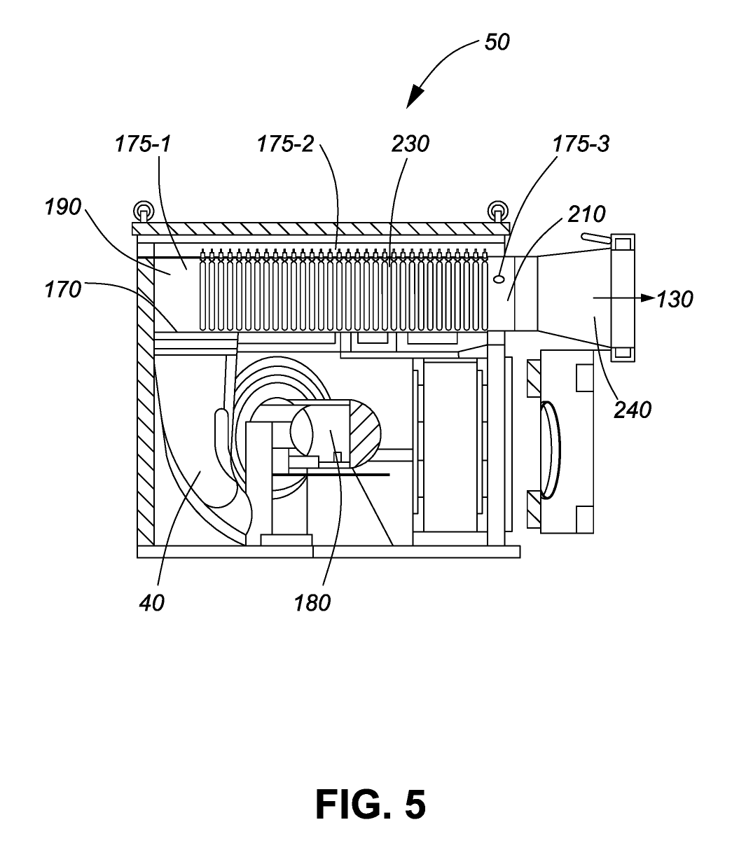

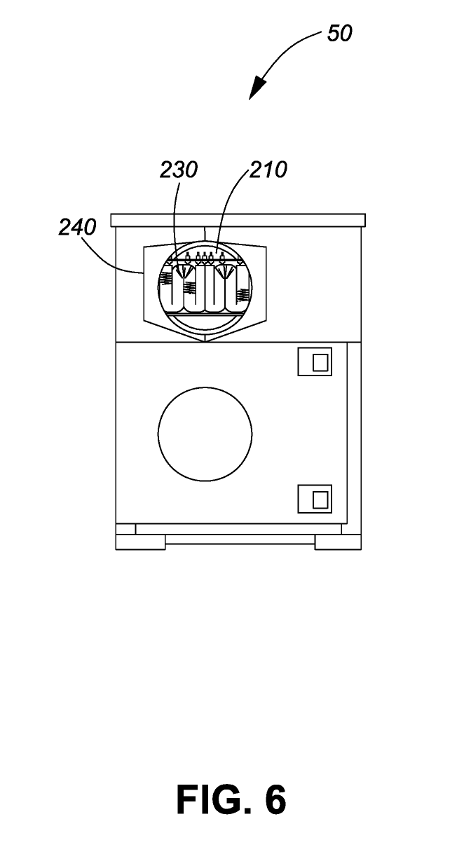

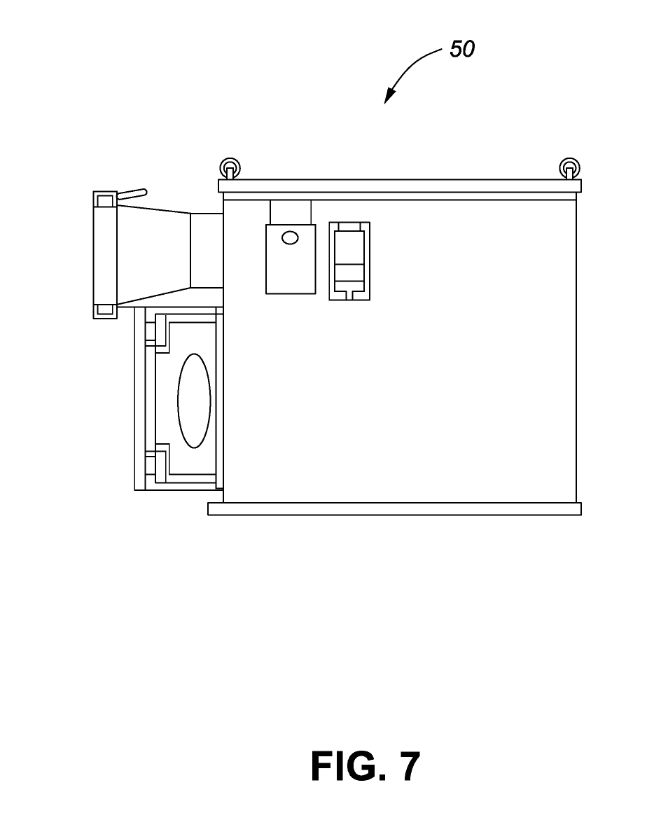

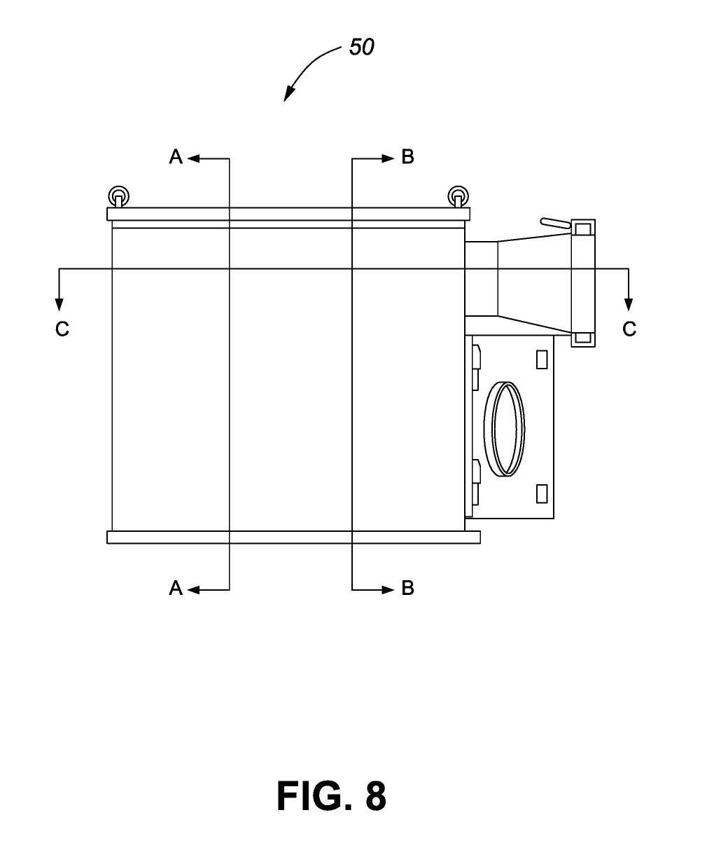

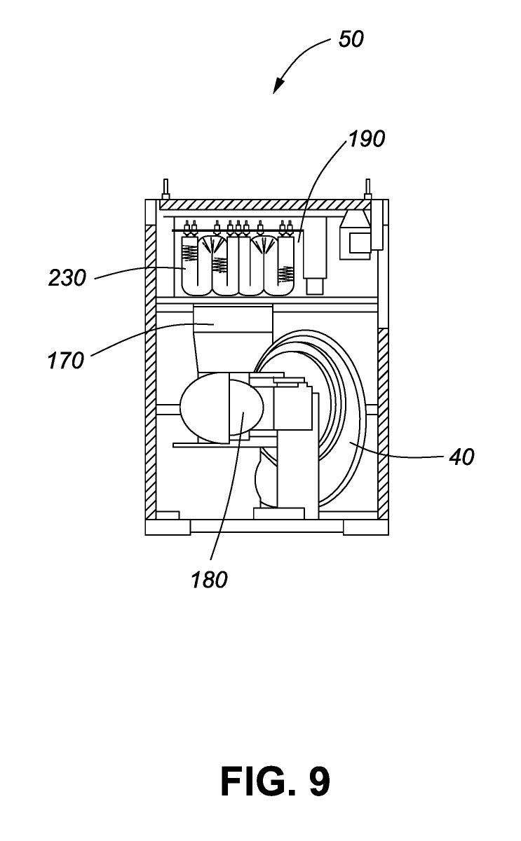

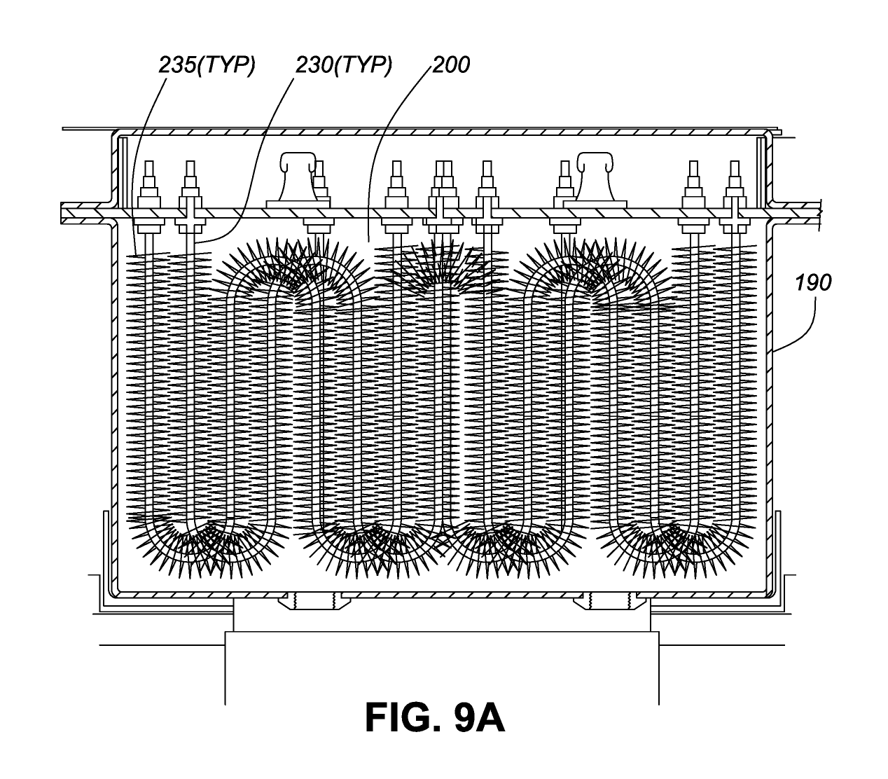

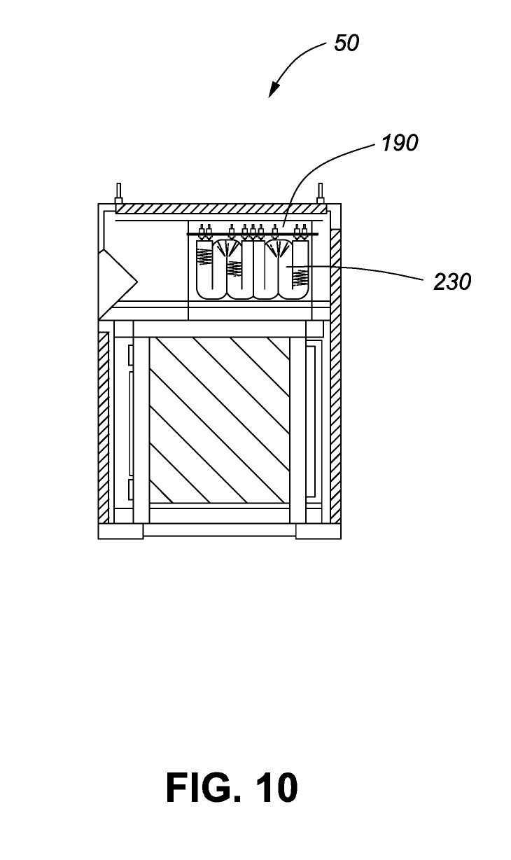

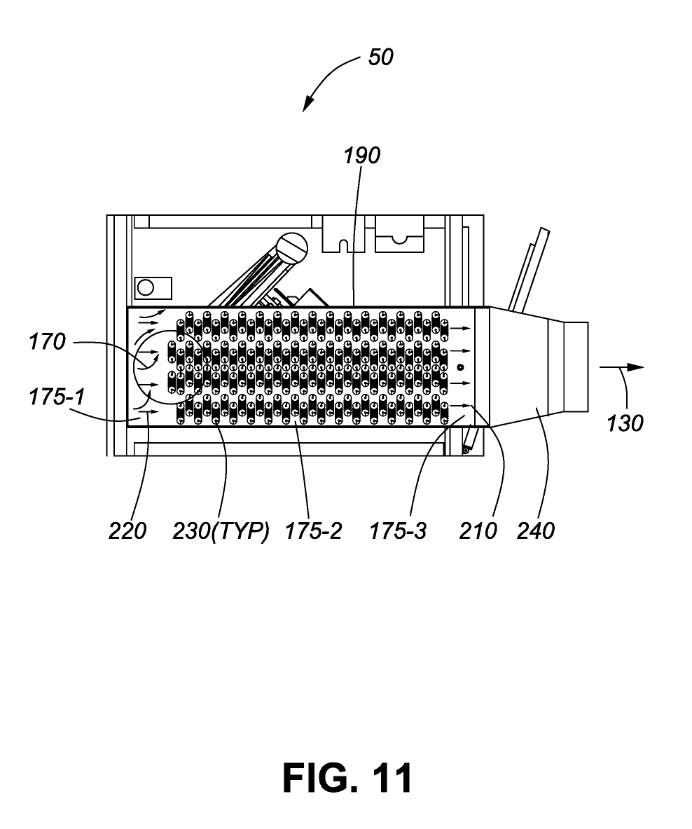

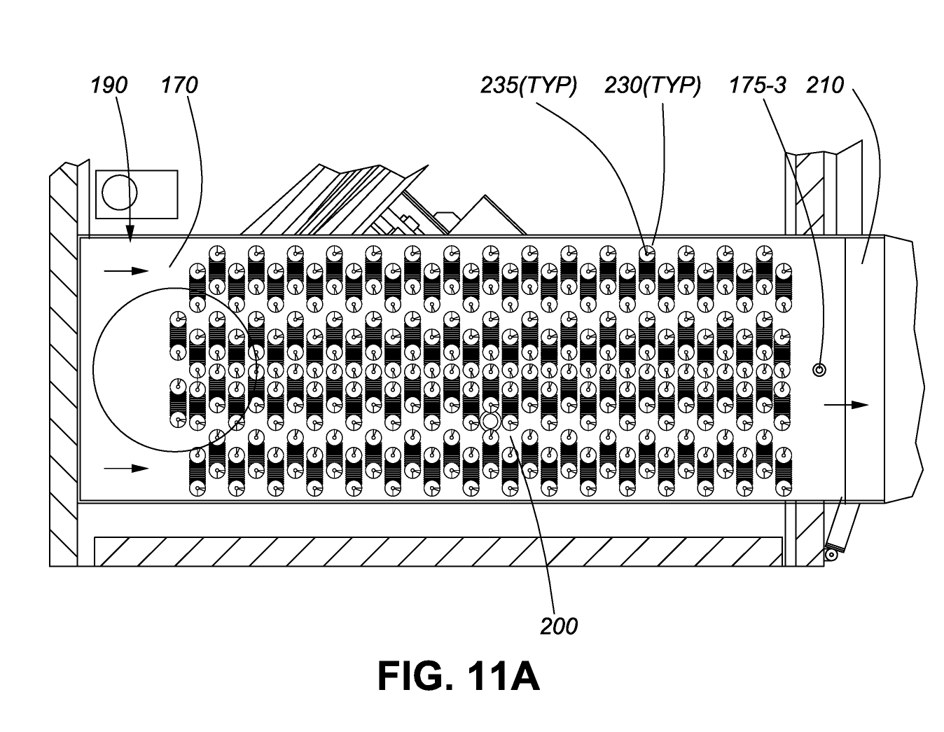

Referring to FIGS. 2-11A, the electric resistance heater 50 has a heater box 190 with an expansive plenum 200, between an inlet 170 and an outlet 210, forming a heat path 220 across a plurality of resistive heating elements or coils 230. Electricity is passed through the plurality of heating elements or coils 230 in a controlled manner, and heat is generated due to the resistance, and the heat transferred to the air flowing past the plurality of heating elements or coils 230. The heating elements or coils 230 may include fin(s) 235 to enhance heat transfer or induce eddy air currents or turbulent flow or combinations thereof.

In an embodiment disclosed, the heat path 220 may be between about 10 inches and about 12 feet long or even 50 feet long or longer. The airflow at the inlet 170, and through the heater box 190 forms eddy currents and/or an interrupted air flow and/or disturbed air flow to decrease the speed/velocity of the air and/or spread out/distribute the air to increase turbulence and improve heat transfer efficiency from the plurality of heating elements or coils 230. The plurality of heating elements or coils 230 may include one or more heat transfer fins 235 to improve heat transfer to the flowing air. Heated breathable air 130 is provided at the outlet 210.

The heater box 190 may be enlarged between the inlet 170 and the outlet 210 to reduce the speed/velocity of the air to provide increased contact time between the air and the plurality of heating elements or coils 230. A nozzle or ducting 240 at the outlet 210 may be used to increase the velocity of the air.

The electric resistance heater 50 may be operated in a manual mode or an automatic mode and may be remotely operated in a remote operation mode.

In the manual mode, a user can set the temperature and blower fan speed for example by local inputs 250 which could be for example pots rheostats or a touchscreen input, with an output viewable on a display 260 or by an application (app) running on a mobile computing device 326, such as a computer or handheld device such as a mobile phone or tablet, and the electric resistance heater 50 will run at a heat output, which may be defined by an operating envelope based on differential temperature (heat rise) and blower speed. In an embodiment disclosed, the electric resistance heater 50 may provide a heat output (for example about 100,000 BTU, 600,000 BTU to 10,000,000 BTU) or provide or a temperature rise (for example about 100 to 600° F.) with the fan at full speed. If the fan speed is lowered the temperature rise will increase, for example to about 235° F. or 265° F., for Class I Div 1 hazardous classification. However, if not restricted for use in such an environment, the temperature rise may be much higher.

In the remote operation mode, the electric resistance heater 50 may be operated/controlled via a connection or signal from/to an external mobile computing device 326, such as a smart phone, tablet, laptop personal computer, desktop personal computer, etc. In the remote operation mode, one can remotely operate the electric resistance heater 50 by telecommunications network, for example cellular, satellite, Wi-Fi. Remote operation may include at least start/stop and/or increase/decrease the temperature of the electric resistance heater. Remote operation may also include one or more of GPS tracking, surveillance via the surveillance system, turn on/off the surveillance system, reporting an operation cost per hour, set or report the speed of the fan or blower, and troubleshooting.

In the remote operation mode, upon starting the electric resistance heater 50 the electric resistance heater will go through a pre-warm up cycle, starting with a slow fan speed and full power to the plurality of coils or hot plates and then the fan speed will ramp up to a set point (for example, about 100,000 BTU, 600,000 BTU to 10,000,000 BTU) and will run like that until the selected temperature (for example the set temperature of the room or enclosure). Once at the selected temperature, one or more of the plurality of heating elements or coils 230 or hotplates will kick out and the speed of the blower fan will increase to about wide open to cool the heating elements or coils 230 or heat box 190 and circulate the complete room or tank or substructure or whatever is being heated up for humidity. This helps keep the room or enclosure at a more consistent temperature. When the room or enclosure starts to cool down and the heating elements or coils 230 or hot plates kick back on and the speed of the blower fan will decrease.

The controller 60 may report one or more of the following operating parameters (locally at display 260, locally at an app, remotely at an app, or a combination thereof):

1. BTU Per Hour.

2. Cost Per kilowatt Hour (based on a user provided cost of fuel for the internal combustion engine for the generator).

3. Blower Fan Speed.

4. Blower output air flow (e.g. Cubic Feet per Minute).

5. First Incoming Coil Temperature; First Quarter Coil Temperature; Middle Coil Temperature; Third Quarter Coil Temperature, and Last Coil temperature (to provide a temperature profile along the heat path as the air is heated in the electric resistance heater).

6. Inlet Air Temperature.

7. Outlet Air Temperature transducer.

8. Fail Switch for protection, so if the blower or other component fails, the portable heater system will shut down.

9. Location of the unit, for example by geolocation by a global navigation system such as the Global Positioning System (GPS).

10. Trouble shooting.

In an embodiment disclosed, the fail switch includes a high temperature setting for high temperature shut down, for example loss of the blower.

The controller 60 may include a programmable logic controller (PLC). The PLC will automatically phase the heater current load back with the electrical controller (with the SCR or IGBT with the PLC logic or programming of the PLC) when plugging in extra electrical load to the generator set if the generator 30/engine 20 are already loaded up to the maximum allowable load on the engine 20 or generator 30. For example, if the electric resistance heater 50 and the lights 350 are running at or near the full load/capacity of the generator 30, when adding extra electrical load of some sort like a wellsite shack or other electrical load, the controller 60 will adjust the current to the electric resistance heater 50 to phase it back to allow for the extra load. This allows the unit to continue to run without stalling out the engine 20, overloading the engine 20, or tripping circuit breakers. When the load is released or unplugged, the controller 60 will automatically return the load to the electric resistance heater 50 as needed.

This keeps the engine 20 loaded properly and provides reduced or optimum emissions from the engine 20 when it is loaded properly (emissions tend to be at higher levels when an engine 20 is operated at low or no load).

When the fuel level 75 in the fuel tank 72 drops below a predetermined level, e.g. about ⅛ tank or a reserve volume, the controller 60 will adjust the SCR or IGBT to a conservation mode, to phase the current to the electric resistance heater 50 back to lower the load on the engine 20 to reduce fuel consumption to keep the engine 20 from running out of fuel for as long as possible.

When the fuel level 75 in the tank 72 drops to predetermined level, e.g. about empty, but slightly before the engine 20 runs out of fuel, the controller 60 will automatically shut the engine 20 down as to not to allow the engine to run completely out of fuel and draw all of the fuel lines dry (i.e. run dry). This allows the fuel tank 72 to be re-filled and the engine 20 restarted without the added steps necessary after running an engine dry (especially a diesel engine), such as bleeding off the injectors. By shutting down the engine 20 before it runs dry, it is much easier to restart once the fuel tank 72 has been re-filled.

In case of a leak of exhaust 80 into the ambient air 110 or heated breathable air 130, one or more carbon monoxide monitors 215 may be provided. The one or more carbon monoxide monitors 215 may be provided with one or more visual and/or audible alarm systems and/or may be connected with the controller 60 to shut-down the engine 20 and/or the blower 40.

The electric resistance heater 50 may be dual mode power, to operate on the power from the generator 30 or may be unplugged from the generator 30 and plugged into an available source of electricity, such as another generator (e.g. drilling rig generator), a utility power line, or shore power. This allows, for example a portable light tower 320 with electric resistance heater 50 to be set up and powered by its engine 20/generator 30 to provide light, heat, and power to help the crews set up the rig. Once the rig is set up and operational, the rig generator can be used to provide electricity to the electric resistance heater 50 or lights 350 or both, because the rig generator would be running anyway.

In an embodiment disclosed, the electric resistance heater 50 may be rated for electrically hazardous area locations. In an embodiment disclosed, the electric resistance heater may be rated for hazardous area locations Class I (locations in which flammable vapors and gases may be found), Division 1 (locations in which ignitable concentrations of hazards exist under normal operation conditions and/or where hazard is caused by frequent maintenance or repair work or frequent equipment failure), and have a temperature rise over 100° F. or 200° F. or other temperature rise.

In an embodiment disclosed, the electric resistance heater is rated as “explosion proof” and rated for Class I, Division 1, gas groups C, D, & E.

In an embodiment disclosed, the electric resistance heater is rated for Class I, Division 1, T3, with groups C, D, and E. The T3 rating dictates the maximum allowable temperature of 392° F. The temperature limit may take into account the heat soak of the electric heater 50, such that even in the event of the loss of the pressurized air source 40, the temperature would not exceed 392° F. In an embodiment disclosed, the temperature is thus limited to about 340° F.

There are a variety of different kinds of resistance heating elements, coils and hotplate type heating elements. In an embodiment disclosed, the heating elements or coils 230 are rated for a certain resistance or watts, and applying an amount of voltage (volts) and current (amps), they heat up to a certain temperature. Further, the electric resistance heater 50 may be3-phase, and depending on how one wires the heating elements or coils 230, the temperature may be impacted. For example, for a given amount of current, such as 100 amps, if the heating elements or coils 230 are wired in a delta or a Y or a Star or in series or in series parallel will make a difference in the temperatures and the current draw.

If one were to wire them in a Wye configuration, fewer heating elements or coils 230 can be used, as it would draw more current (and the current is limited by the output of the generator 30 or power line) and either the circuit breaker would kick out or the heating elements or coils 230 will get way too hot, for example for a temperature rating of 392° F. and the heat path 220 becomes too short to obtain the desired air temperature rise needed. However, if wired in a Delta configuration, the resistance of the heating elements or coils 230 is changed, and with for example 100 amps, more coils can be used and this keeps the temperature of the heating elements or coils 230 lower and more time in the heat path 220 increases the air temperature to get the temperature rise up to a desired temperature rise, while maintaining the maximum allowable surface temperature of 392° F. However, as an additional factor of safety, limiting the surface temperature to about 320° F. accounts for a scenario where the pressurized air source (e.g. blower) fails or burns out, and even with the heat soak, the temperature will not exceed 392° F. (in one embodiment the maximum temperature reached only 360° F.).

In an embodiment disclosed, an electric resistance heater 50 sized for 100 amp service (e.g. from a generator 30 or a power line) runs at about 96 percent efficiency (in one trial, the outlet air temperature was 19° F. less than the temperature of the heating elements or coils 230, and in another trial, the temperature of the air at the outlet 210 was within about 3° F. less than the temperature of the heating element or coils 230 (at the outlet 210), while drawing about 85 amps out of the 100 amps, including 22 amps to run the blower at full speed with 54 coil heating elements producing about 600,000 BTU. In an embodiment disclosed, an electric resistance heater 50 sized for 100 amp service, one may add more heating elements or coils 230, for example 9 more, so there will be 63 heating elements or coils 230 total, so that with the blower at full speed, the system will draw about 95 amps, just enough to keep a 100 amp breaker from kicking out. In this embodiment, the system will produce about 750,000 BTU at 100 amps.

In an embodiment disclosed, the electric resistance heater 50 may be provided with redundant heating elements or coils 230 that may be replaced if there is a failure. If you lose a heating element or coil 230 you would not even notice that it was burnt out. This allows the equipment to complete the required job and the maintenance or repair to be deferred until an appropriate time (e.g. after the job or between jobs).

In an embodiment disclosed, the electric resistance heater 50 may be rated Class I, Div. 1 T3 or explosion proof, and the heating elements or coils 230 must be potted to meet the certification. In such embodiment, one would normally have to replace the entire heating element section, for example if there are a number of failures such that the remaining number of good heating element coils falls below a minimum. In an embodiment disclosed, the electric resistance heater 50 may be provided with a plurality of redundant or excess heating elements or coils 230, for example about 9 excess heating elements or coils 230. Such a configuration would allow the failure of up to 9 heating elements or coils 230 before the electric resistance heater 50 would require derating.

In an embodiment disclosed, the temperatures of the heating elements or coils 230 are controlled by a silicon controlled rectifier (SCR). In an embodiment disclosed, where surface temperature is limited, such as an explosion proof location, an insulated-gate bipolar transistor (IGBT) may be used instead. In an embodiment disclosed, a double set of off/on contactors may be provided. In general, the SCR and IGBT provide a variable control whereas the contactors provide an on/off control. Only one (for the amount of current) is required for Class I Div 1 T3, but a double contactor is required for safety to get the Class I Div 1 T3 electrical rating. Heat created by the SCR or IGBTs in a control box 65 may also be used to pre-heat the ambient air 110. For example, the SCR or IGBTs may be within the control box 65, and at least a portion of the ambient air 110 may be conveyed through or across the control box 65. One or more heat transfer fin(s) 67 may be provided to enhance the heat transfer. As another example, the ambient air 110 may be conveyed through or across the electric control components and across the motor 180 and through the blower 40 to pre-heat the air and then to the electric resistance heater 50 to increase efficiency.

A person skilled in the art will recognize that the portable heater system 10 may be scaled to a relatively wide range of sizes. Suitable sizes include, but are not limited to, 20 amps, 100 amps, 150 amps (787000 BTU) or 1,100,000 BTU.

The heated breathable air 130 may be used for a variety of purposes, including direct heating of an enclosed space or building 270, for example a control room, wellhead enclosure, a metering station, a valve station, a tank or vessel 280, a segment of a pipeline 290, a gas plant, a compressor station, a high rise building under construction, a workshop, an aircraft hangar, an airport, a tent or other temporary structure, or an environmentally controlled workspace (for example to keep stucco or concrete warm while it can cure in the winter time when temperatures fall below a minimum temperature for curing), or heating of equipment (such as earth moving equipment, construction equipment, oil and gas drilling equipment, agricultural equipment, aircraft etc.).

Smaller items or specific components may be warmed/heated for example by a portable wand or hot air heat gun 310 connected to the electric resistance heater 50 by a hose, stainless steel hose, or other conduit 300 to apply the heated breathable air 130 in a more specific/targeted manner, such as thawing out valves.

In an embodiment disclosed, an electric resistance heater 50 may be incorporated into a portable wand or hot air heat gun 310 or the heated breathable air 130 may be provided to a portable wand or hot air heat gun 310 by a hose or other conduit 300 from an electric resistance heater 50.

If the electric resistance heater 50 is incorporated a portable wand or hot air heat gun 310, the portable wand or hot air heat gun 310 may be supplied air from an air compressor, for example a continuous screw compressor, at 50 or 80 psi to 120 or 350 psi at approximately 60 CFM (up to hundreds of CFM or 1000 CFM or more) and it passes through the electric resistance heater 50 in the portable wand or hot air heat gun 310 to provide heated breathable air at between about 350 to about 1500° F.

If the electric resistance heater 50 is stand-alone or incorporated into a light tower 320 as described herein (rather than incorporated into the portable wand or hot air heat gun 310), the heated breathable air 130 is delivered to the portable wand or hot air heat gun 310 through a hose or other conduit 300 extending between the outlet 210 of the electric resistance heater 50 and the inlet of the portable wand or hot air heat gun 310. The hose or other conduit 300 may be stainless steel hose suitable for the temperature and insulated for efficiency and safety. The hose or other conduit 300 may be electrically traced or heated to reduce loss of heat from the heated air. The electrically traced or heated hose or conduit may be used to maintain the temperature of the heated air, for example up to 600° F. (subject to the allowable electrical classification). The hose or other conduit 300 and electrical or heat tracing must be rated/limited for the area where it is used, for example CSA or Class 1 Div 1 (T3) or other rating (such as Class 1 Div 1 and/or general purpose and/or unrestricted).

Alternatively, the hose or other conduit 300 may be heated using the heated breathable air 130, for example in a double-wall or wrapped configuration, where a portion of the heated breathable air 130 from the electric resistance heater 50 is circulated through the double-wall or wrapped hose or conduit and vented to atmosphere proximate (but still a safe distance from the user/portable wand or hot air heat gun) to keep the hose or other conduit 300 heated and the remaining heated breathable air 130 is conveyed through the hose or other conduit 300 to the user.

In an embodiment disclosed, the compression of the air adds heat to the air, for example as the pressurized air source 40. In an embodiment disclosed, a general purpose air compressor that puts out 400 to 1000 CFM at 10 to 15 PSI may provide a temperature rise of 145° F. before the air enters the electric resistance heater 50. In a further example, at 650 CFM, a blower may provide 50 psi air at 450° F. out of the blower. Reducing the speed of the blower to 350 CFM provides 50 psi air at 550° F.

The hose or other conduit 300 may be from 10 feet to 1000 plus feet long and may be from ½″ to 2″ Inch in size, for about 6 psi to 350 psi. The hose or other conduit 300 may be sized according to typical sizing requirements, such as pressure drop.

The portable wand or hot air heat gun 310 may be useful for a variety of uses, including:

1. Thawing out valves, for example on wellheads or frac trucks or culvert pipe or rigs or other uses.

2. Melting snow around a rig or wherever.

3. Heating up equipment without the use of water.

It takes about five times the amount of power to make steam versus hot air, so using air is more energy efficient. Using hot air is safer than using steam, as steam tends to create a foggy mist in freezing temperatures which hinders vision, whereas hot dry air does not. Using hot air is also safer than using steam, as steam even at 350° F. would burn a workers hand badly due to the moisture from the steam soaks into the workers gloves. Conversely, with hot air even at 1500° F., just one foot from the end of the hose or hot air outlet you will not burn your hand without a glove on you will not burn your hand unless you hold It there for a period of time (if steam, one would be badly burned instantly).

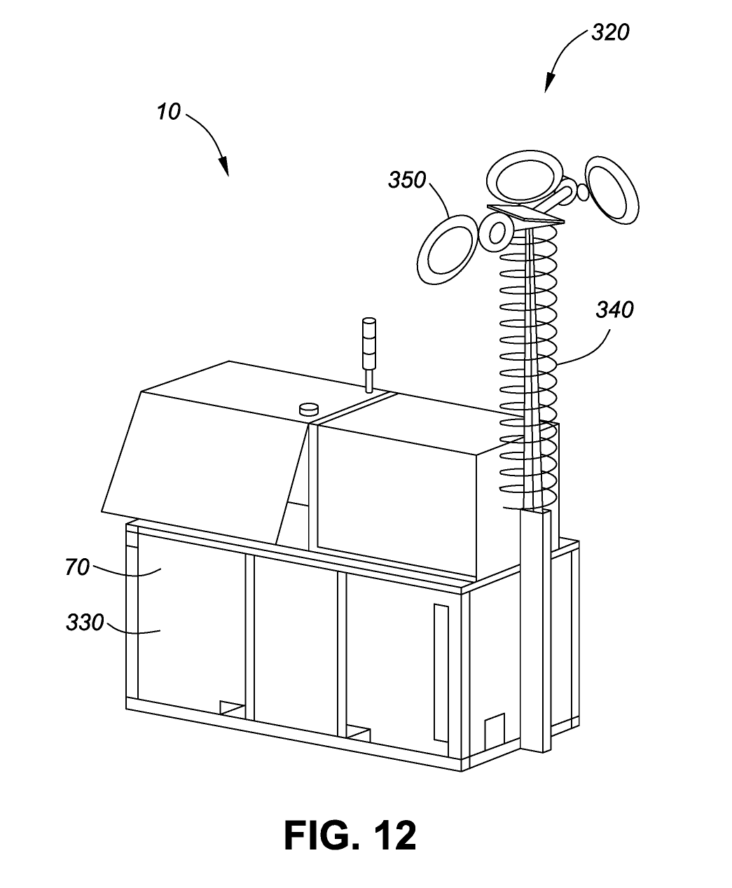

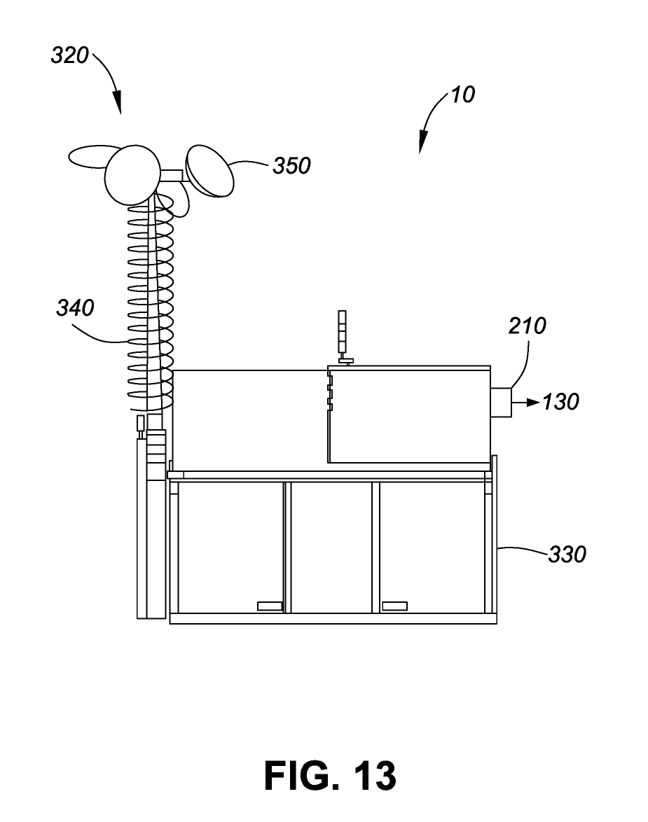

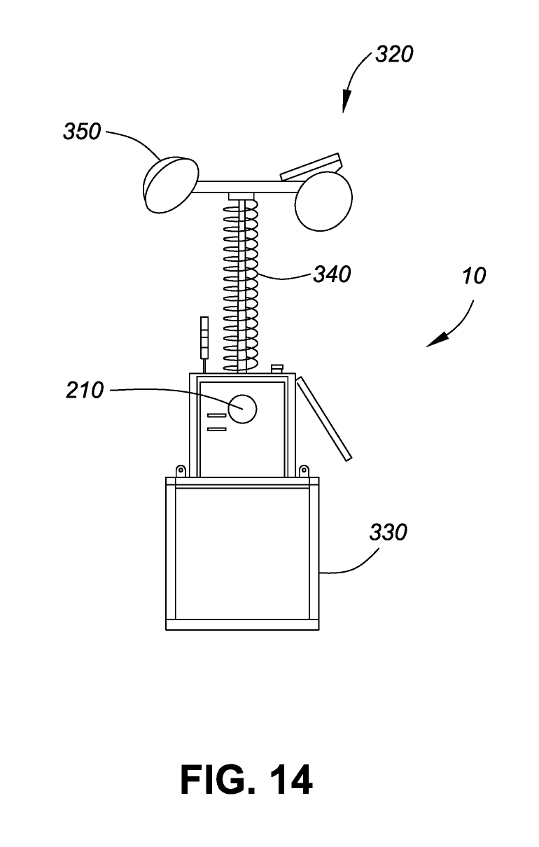

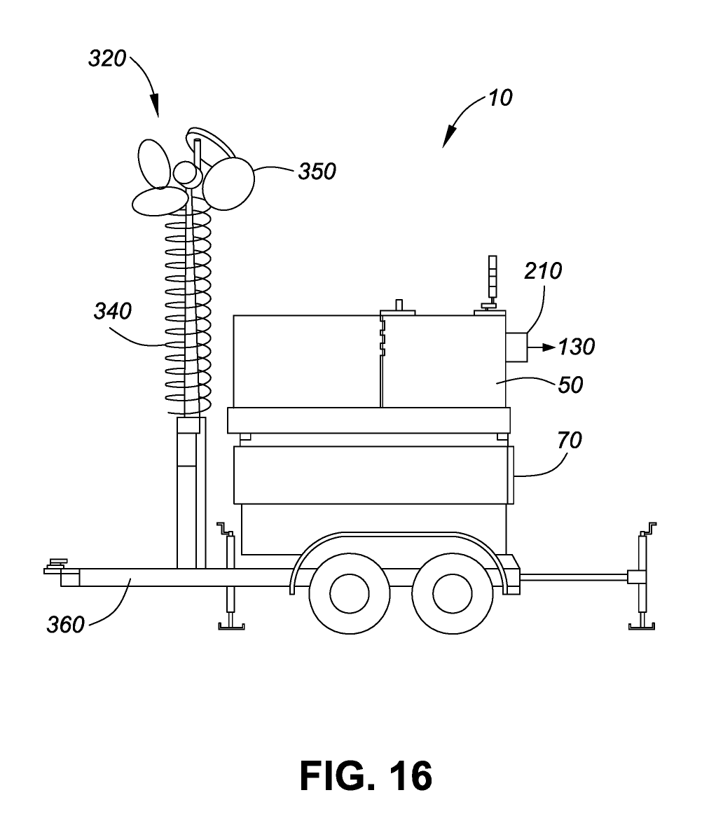

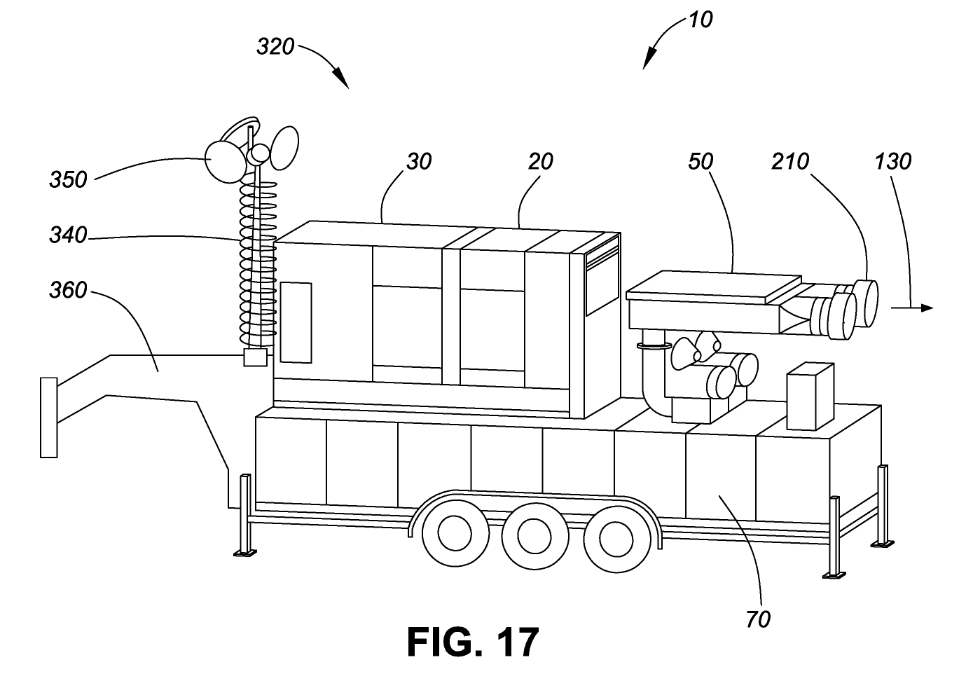

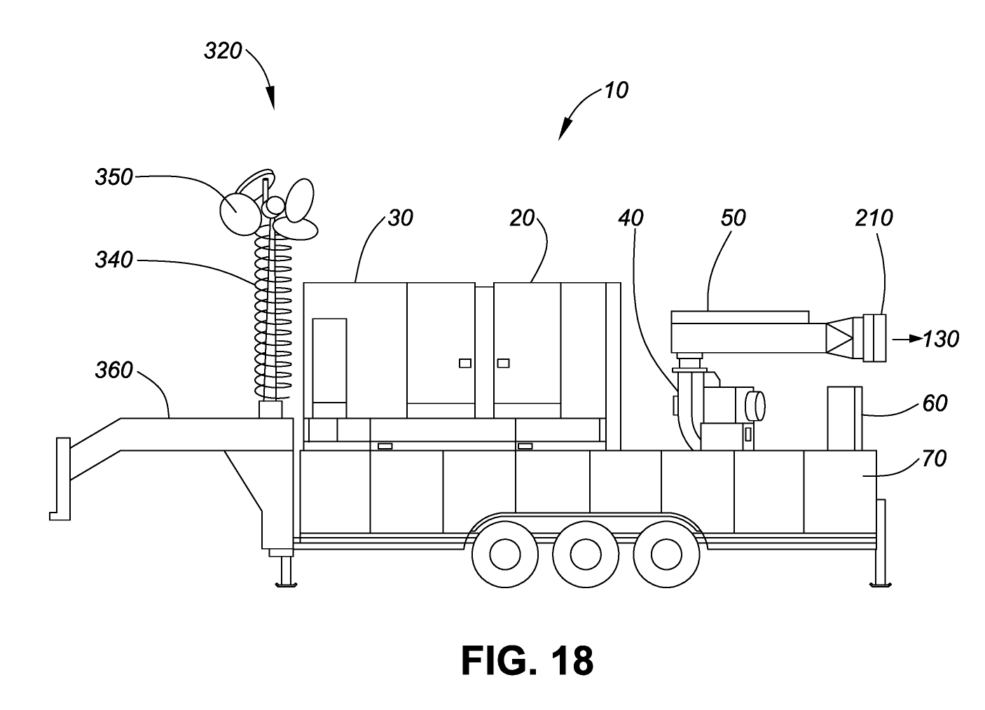

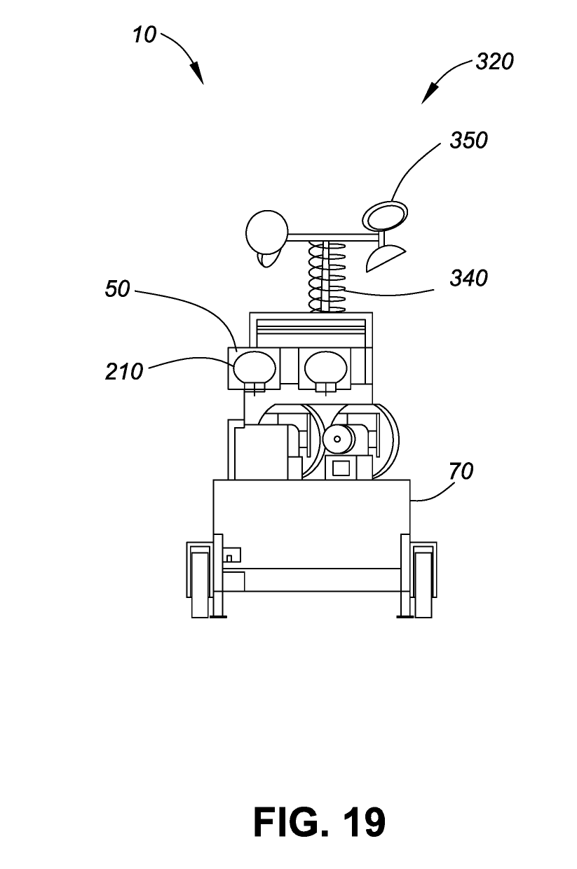

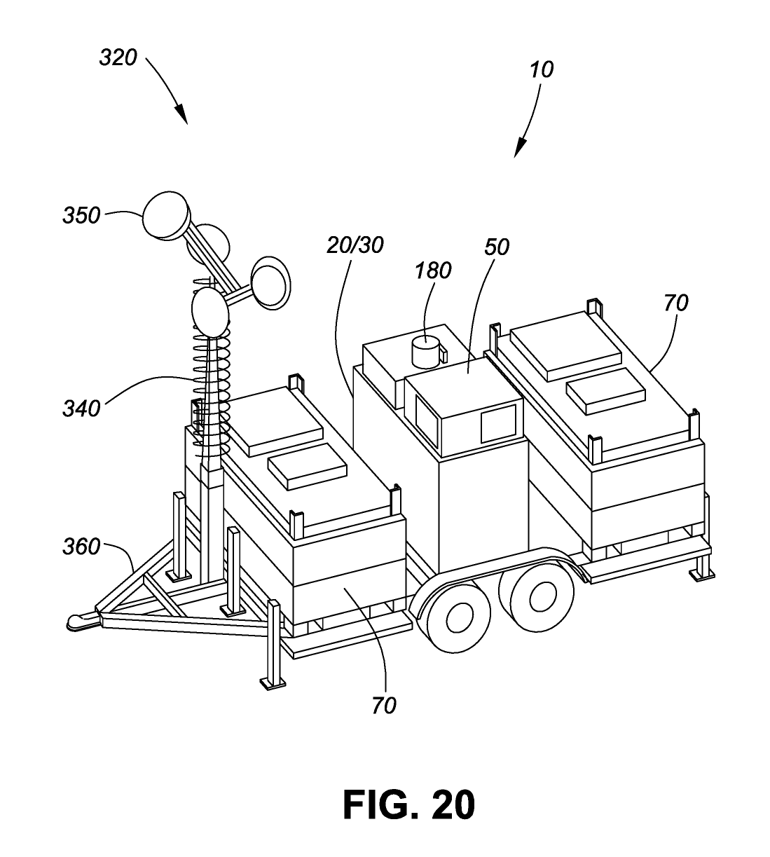

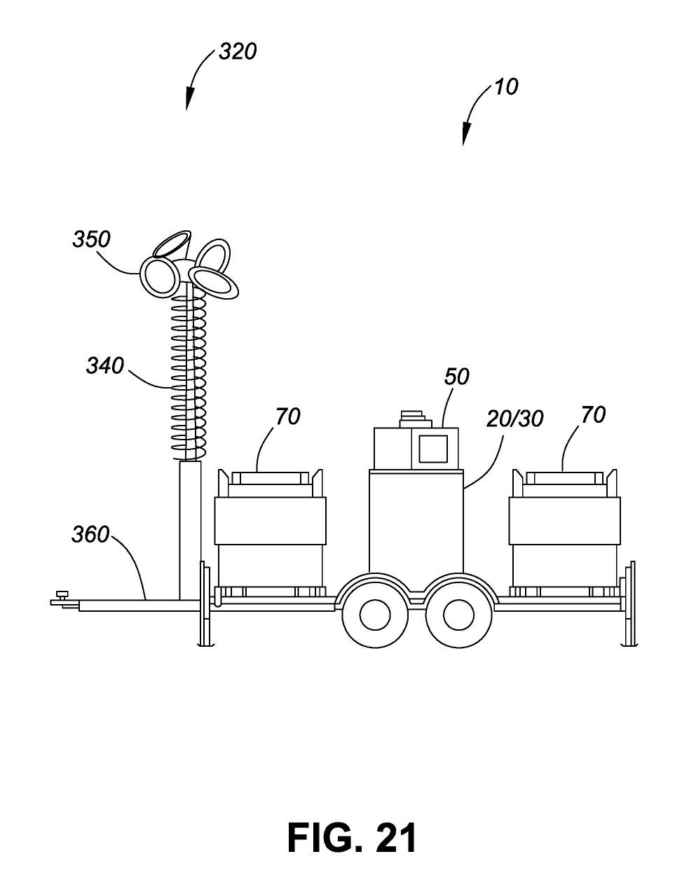

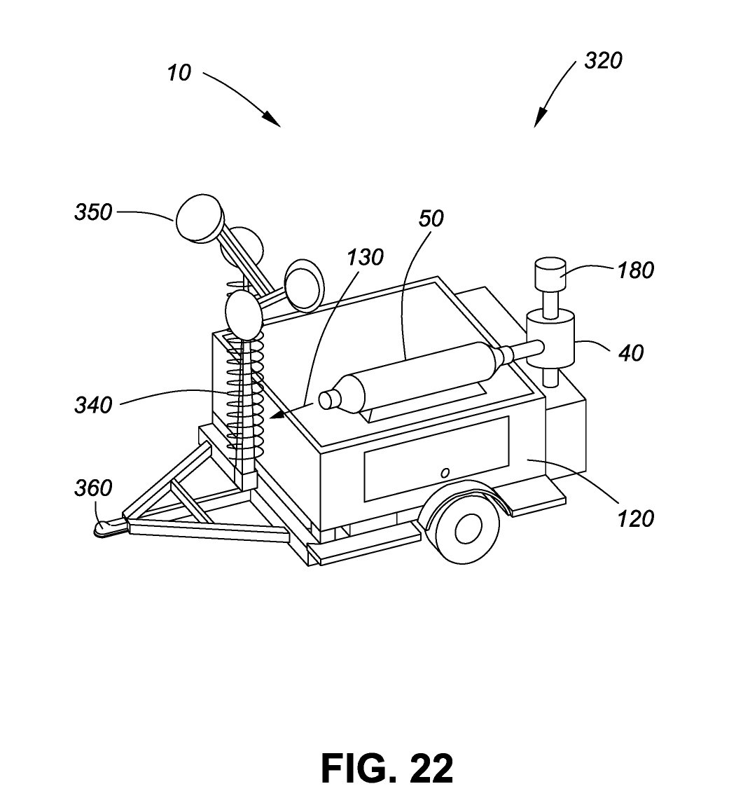

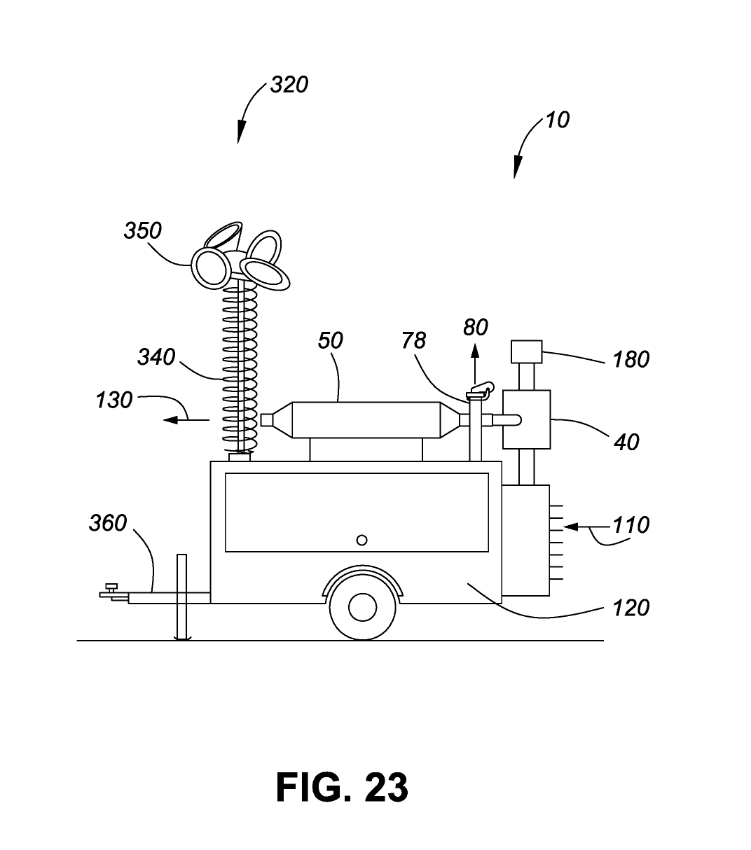

Referring to FIGS. 12-23, the portable heater system 10 (including electric resistance heater 50) may be embodied in a portable light tower 320. The portable light tower 320 includes a mobile base 330, a portable heater system 10 (with electric resistance heater 50) as described herein with a pressurized air source 40, a controller 60, and an engine 20 driven generator 30 for powering the electric resistance heater 50, the pressurized air source 40, and the controller 60, and a mast 340 with one or more lights 350 powered by the generator 30.

The portable light tower 320 may be moved to a selected location, for example a remote work location, such as a well site. The mast 340 can be raised and the generator 30 operated to power the one or more lights 350 or the electric resistance heater 50 or both.

The one or more lights 350 may be halogen lights, or preferably light emitting diode (LED) lights. In an embodiment disclosed, the one or more lights 350 are LED lights operating at about 208 volts or 230 volts. For the same light output (lumens), LED lights use less current than halogen, which leaves more current for the electric resistance heater 50. For example, in one comparison, four halogen lights on 110 volt may require 30 amps. Whereas, four LED lights on 110 volts may require 9 amps, and four LED lights on 220 volts may require only 2.5 amps.

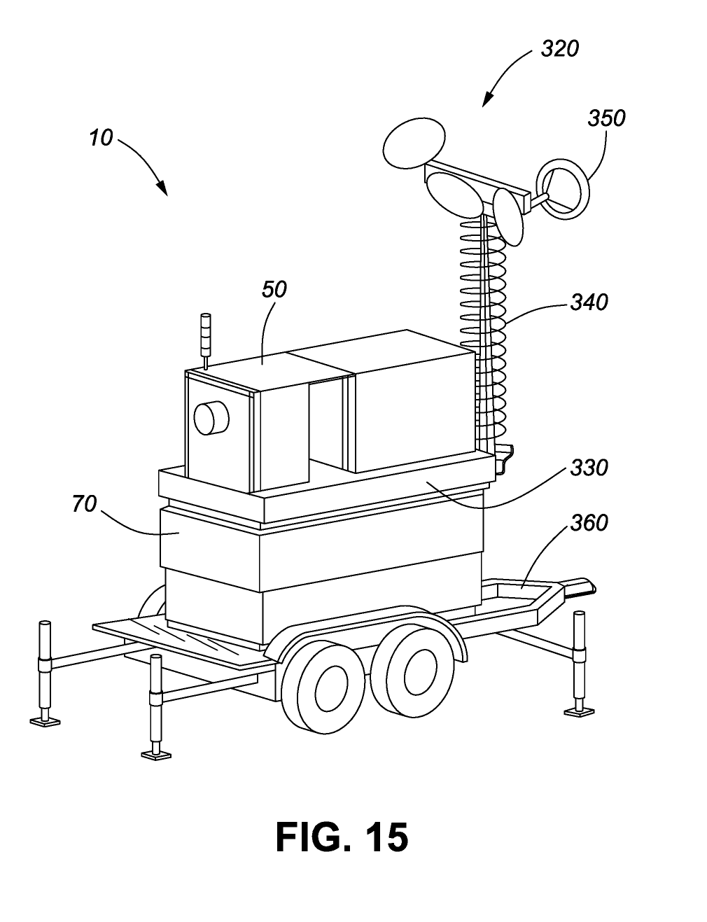

Referring to FIGS. 15-23, the portable light tower 320 may be provided in a trailer configuration 360 with an integral trailer frame or removably attached to the deck or frame of a trailer.

In an exemplary embodiment, a 6 kW electric resistance heater 50 may be used to provide heated breathable air to a wellhead enclosure. With the pre-heat described herein, the engine would burn about 1.5 litres (0.4 gallons) of fuel an hour. With a typical 250 gallon fuel tank, the portable heater system could run for about a month (26 days).

In an embodiment disclosed, a high performance fan blade that has a high pitch angle that puts out more air volume and more static pressure than a normal fan blade may be used with the engine 20 driving the generator 30. The high performance fan blade is used to push air through the radiator 90, over the engine muffler (i.e. heated by the exhaust 80) and through an electric resistance heater 50 (and through hose or other conduit 300 to the wellhead building or fiberglass hut that house the wellhead or value assembly or instrumentation). In embodiments disclosed, the air volume and pressure supplied by the high performance fan may be sufficient, such that a dedicated blower 40 is not required. In this embodiment, for example, a 6 kW diesel engine will use 1.5 litres of fuel per hour and with a 1512 litres or 400 gallon dual containment fuel tank, would run for approximately one (1) month before needing refueling. This reduces the fuel cost and reduces the number of trips and associated refueling service cost and risk of accidents and fuel spills.

In an embodiment disclosed, the portable light tower 320 may include a communication system 322 having a communication device 324 (such as one or more antenna, dish, transponder, radio, transceiver etc.) to provide a telecommunication link between the portable light tower 320 and a mobile computing device 326 of a remote user, to provide reporting or send/receive control signals or status/information or combinations thereof. The telecommunication link may provide a direct link between the portable light tower 320 and the mobile computing device 326, or may include one or more intermediate telecommunication networks, e.g. internet or cellular network, or intermediate devices, e.g. computer servers, to form the link indirectly. The link may be real-time or near real-time, or the reporting, control signals, or status/information may be stored on an intermediate device, such as a memory or a remote computer server, and then accessed by the communication system 322 or the mobile computing device 326 or both.

Where the communication system 322 requires an elevated antenna, dish, transponder, radio, transceiver, etc., a dedicated communications tower may be provided or the antenna, dish, transponder, radio, transceiver etc. may be mounted on the mast 340.

In an embodiment disclosed, the portable light tower 320 may include a surveillance system 332 with one or more cameras 334 for capturing still images or video or audio or combinations thereof. The captured information may be stored in a memory 336 such as flash memory or a magnetic or optical media. For example, the captured information may be stored for a period of time, such as 30 days, and then it will be overwritten (so that the last 30 days is always available). The captured information may include still images, videos, sound, and operating data such as inlet air temperature, outlet air temperature, engine oil pressure, engine oil temperature, fan speed, cost per hour to run on fuel, fuel tank level, or combinations thereof. A processor 338 may execute instructions to retrieve the captured information from the memory 336 and convey it to a mobile computing device 326 via the communication system 322. The camera 334 may utilize a wide-angle or 360 degree view or may be panned to provide a wide field of view. The images or video may be streamed live, or may be captured and sent periodically such as every minute, hour or day, or may be captured and sent upon a triggering event. Triggering events may include the detection of movement in the field of view of the camera 334, detection of movement detected by a motion sensor, activation of a tamper switch associated with the heater (such as opening a panel), or movement of the portable light tower 320 from its location. The camera 334 may be mounted on the mast 340 or otherwise mounted on the portable light tower 320 or proximate the light tower.

Referring to FIG. 1, in operation, ambient air 110 is drawn though the radiator 90 and/or the enclosure 120 by the fan 100 and/or by the blower 40. The ambient air 110 is thus pre-heated to some degree. The air may be further heated by compression as it passes through the blower or compressor 40. The pre-heated air is then further pre-heated by the exhaust 80 from the engine 20, and then enters the flameless electric resistance heater 50. In the electric resistance heater 50, the air is heated to the conditions set by the controller 60, and heated breathable air 130 is delivered.

Referring to FIGS. 12-23, in operation, the electric resistance heater 50 works as described above. In addition, the mast 340 is raised to an operating position and lights 350 activated to illuminate a work-area. The heated breathable air 130 may be delivered to the illuminated work-area or an enclosure or building or combinations thereof. When plugging into a well site shack with the heater and the light tower running at ¾ load with the load from the resistance heater and the light running the controller will automatically phase back the heater so the well site shack receives a sufficient amount of electrical current/power to run the well site shack and it will not overload the generator or stall out the generator engine. If the electrical load or well site shack is unplugged or turned off, the controller will automatically send more current back to the heater to take it back up to full capacity of the heater once again.

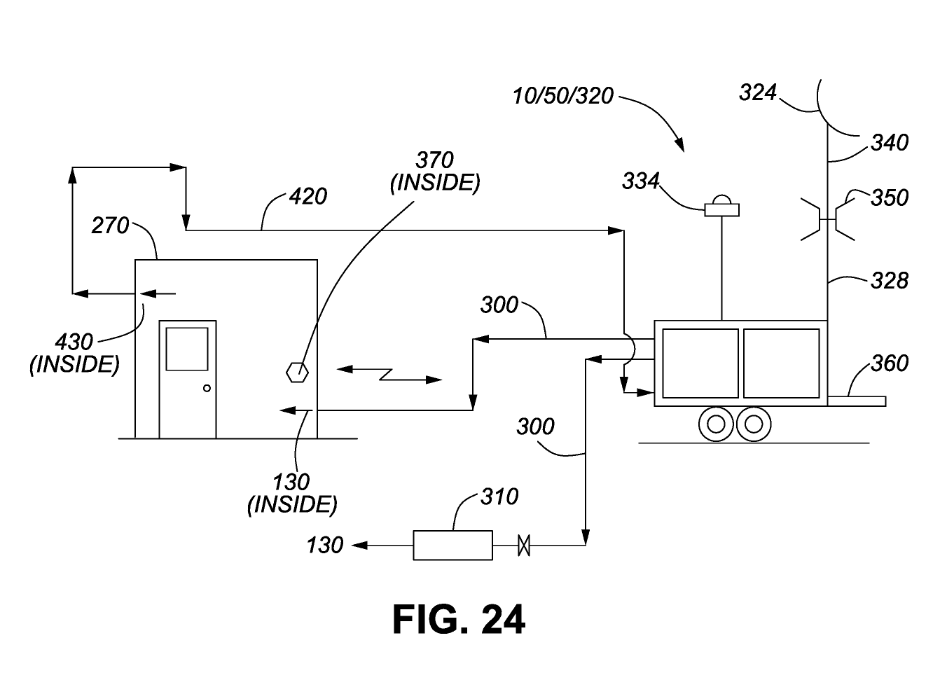

Referring to FIG. 24, the portable heater system 10 with electric resistance heater 50 or portable light tower 320 with electric resistance heater 50, works as described above. The heated breathable air 130 is delivered to the interior of an enclosed space or building, such as a enclosed space or building 270 (e.g. wellhead enclosure) via a hose or other conduit 300. In an embodiment disclosed, a wireless temperature remote system 370 is provided in the enclosed space or building 270 (e.g. wellhead enclosure), which senses/measures the temperature and the sensed/measured temperature signal is received by the associated wireless receiver 375 and used by the controller 60 to control the electric resistance heater 50 or blower 40 or both to maintain a temperature set point. The wireless remote temperature system 370 and associated receiver 375 preferably are capable of forming/maintaining a connection through metal buildings or equipment and with a 5-kilometer range, in order providing a temperature measurement in such conditions. In an embodiment disclosed, the temperature may be maintained within about plus or minus 2° C. or ° F. In an embodiment disclosed, a wired connection may be used instead of wireless.

Because the heated air is 100% breathable and does not consume oxygen, it can be recirculated to improve efficiency (in contrast to fired heaters or heaters that use flue gas directly such as propane or natural gas burners, with the carbon monoxide, carbon dioxide, etc. below some safe threshold, where recirculation would result in a gradual rise and accumulation of carbon monoxide, carbon dioxide, etc. in the heated air and would eventually exceed a safe threshold, and further the consumption of oxygen could lead to an oxygen deficient environment if insufficient fresh air is supplied). These problems are avoided with the electric resistance heater 50 of the present disclosure. Ambient air 110 may be drawn into the heater 50, or optionally, at least a portion of the inlet air may be recirculated from the enclosed space or building 270 (e.g. wellhead enclosure) via recirculation line 420. The advantage being that, for example, ambient air 110 may be −20 degrees Celsius and the air recirculated via recirculation line 420 may be about 10 degrees Celsius, so it takes less energy (and ultimately less fuel to the engine 20) to maintain the temperature in the enclosed space or building 270 (e.g. wellhead enclosure). The heated air supply to the enclosed space or building 270 (e.g. wellhead enclosure) (i.e. heated breathable air 130) and the recirculation intake 430 for recirculation line 420 may be at or about opposite ends of the enclosed space or building 270 (e.g. wellhead enclosure) to help circulate the air in the enclosed space or building 270 (e.g. wellhead enclosure). The system may be configured to draw in fresh ambient air 110 or air via recirculation line 420 or a mixture thereof. The proportion may be controlled via a valve and the valve may be manually operable or may be automatically controlled, for example by the controller 60.

Also shown in FIG. 24 is a portable wand or hot air heat gun 310 supplied heated breathable air 130 via a hose or other conduit 300. The heated breathable air 130 may be directed to the portable wand or hot air heat gun 310 or the enclosed space or building 270 or both.

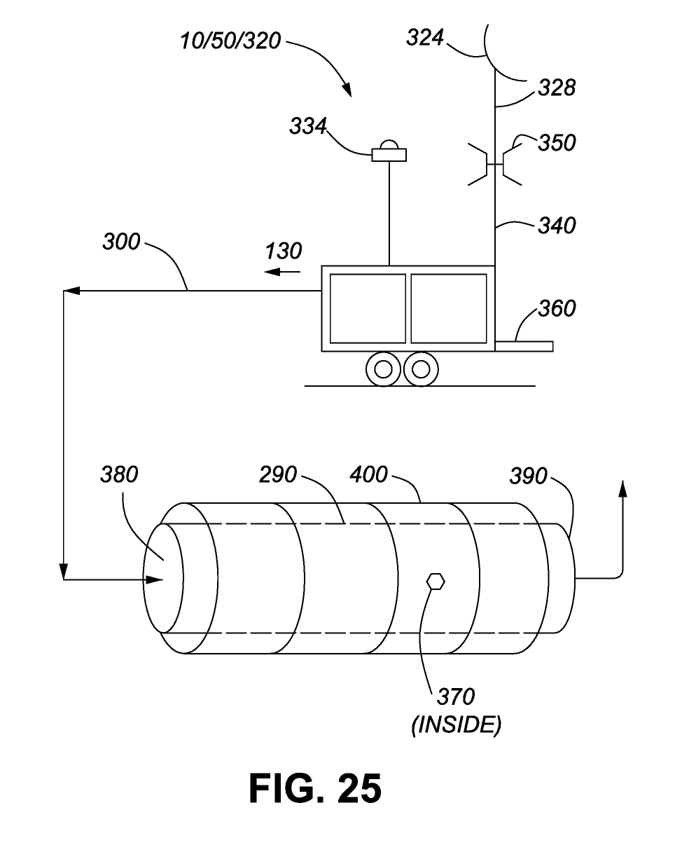

Referring to FIG. 25, the portable heater system 10 with electric resistance heater 50 or portable light tower 320 with electric resistance heater 50, works as described above. The heated breathable air 130 is delivered to the interior of a pipeline segment 290 via hose or other conduit 300 to warm/heat the pipeline segment 290. In such an embodiment, the air flow may be in the range of 1000-10,000 CFM, for example about 1650 CFM, and a temperature between about 400° F. and 600° F., for example about 500° F. In this embodiment, the electric resistance heater 50 may require a power supply of about 150 kW, for example from an appropriately sized genset. The heated breathable air 130 is delivered to the pipeline segment 290, which may be about 1 km to 10 km, for example 6 km in length. The inlet 380 of the pipeline segment 290 may be fitted with a cover or distributer to sealingly engage the hose or other conduit 300. The outlet 390 of the pipeline segment 290 may be fitted with a cover or controllable flow restriction/vent to control the air flow through the pipeline segment 290. Insulation 400 may be provided to reduce heat loss for at least a portion of the pipeline segment 290. If work is to be done on the outside of the pipeline segment 290, the insulation 400 may be removable.

One use of the described technology is in cold environments, such as −40° F. or 0° F., where the pipeline segment 290 must be warmed to a temperature to allow sandblasting, coating/painting, fabrication, welding, movement, expansion or growth test at temperature of steam to simulate operating temperature, or other pipeline activity. The heated breathable air 130 may also be used to dry or condition the inside of the pipeline. A substantially sealed enclosure or hoarding may be provided around the outside of the pipeline segment 290 to use the heated breathable air 130 for similar activities on the exterior of the pipeline segment 290. In an embodiment disclosed, a wireless temperature remote system 370 described above is used as describe above, for example to maintain a temperature inside the pipeline segment 290 required for the pipeline activity. In an embodiment disclosed, the temperature is above the dew point so that condensation or moisture does not form on the pipeline segment 290.

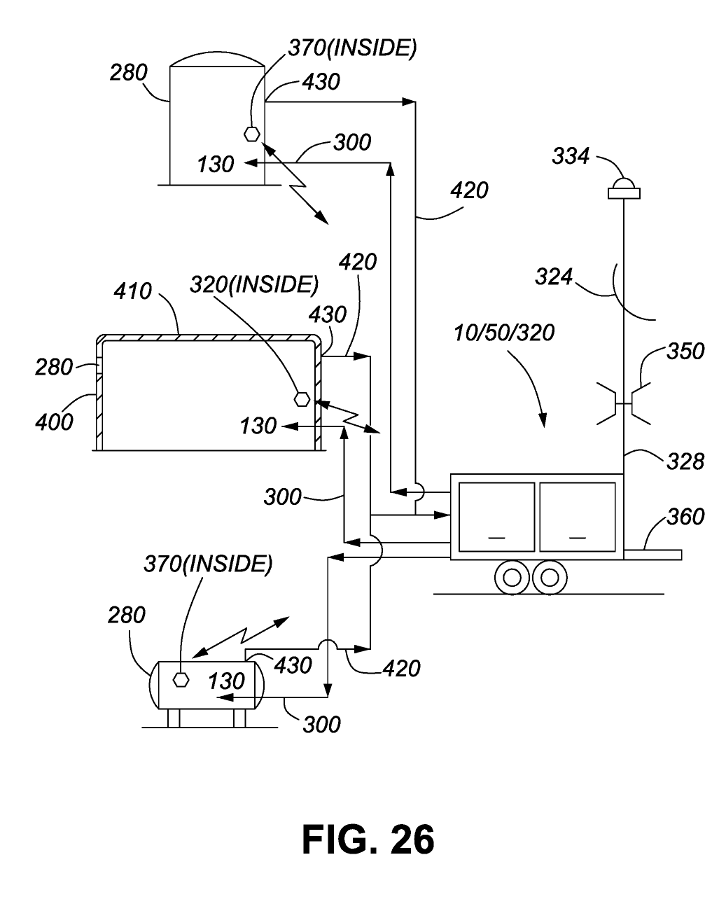

Similarly, referring to FIG. 26, the portable heater system 10 with electric resistance heater 50 or portable light tower 320 with electric resistance heater 50, works as described above. The heated breathable air 130 is delivered to the interior of a tank or vessel 280 via a hose or other conduit 300 to warm/heat the tank or vessel 280. FIG. 26 illustrates a tank or vessel 280 in the form of, a tank, an open roof tank, and a vessel respectively. Depending on the heat demand of the tank or vessel 280 and the heat output of the electric resistance heater 50 of the portable heat system 10 or portable light tower 320, one or more tank or vessel 280 may be supplied heated breathable air 130 at the same time. Insulation 400 may be provided to reduce heat loss. If work is to be done on the outside of the tank or vessel 280, the insulation 400 may be removable.

A cover or hoarding 410 may also be provided to reduce heat loss (if the tank or vessel 280 has an open roof or open wall section or if work is to be done on the exterior of the tank or vessel 280 or combinations thereof).

One use of the described technology is in cold environments, such as −40° F. or 0° F., where the tank or vessel must be warmed to a temperature to allow sandblasting, coating/painting, fabrication, welding, movement or other tank or vessel activity. In an embodiment disclosed, a wireless temperature remote system 370 described above is used as describe above, for example to maintain a temperature inside the tank or vessel 280 required for the tank or vessel activity. In an embodiment disclosed, the temperature is above a temperature (e.g. the dew point) so that condensation or moisture does not form on the tank or vessel 280.

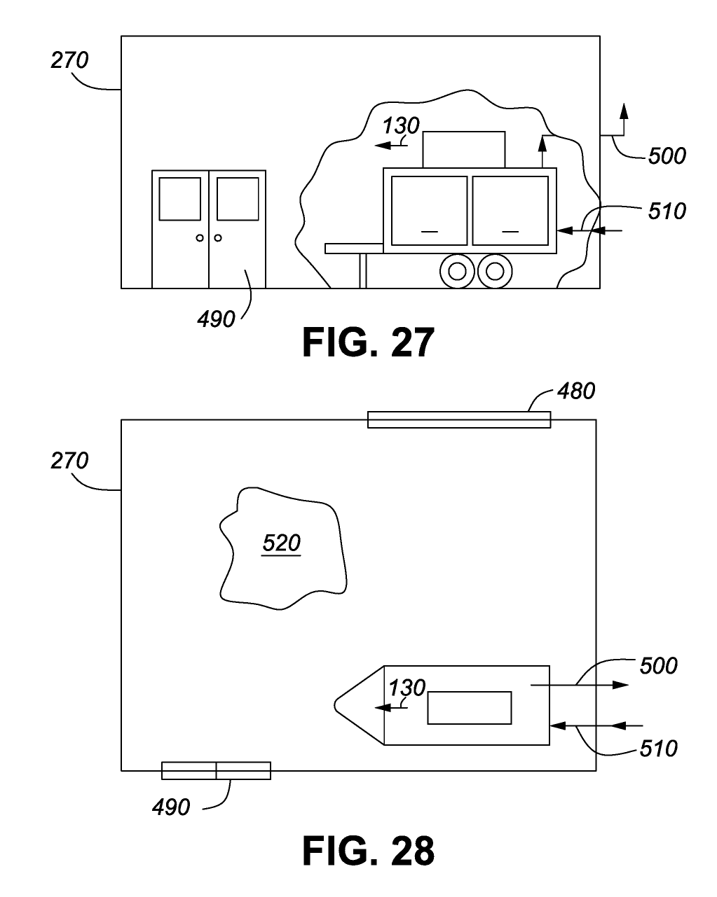

Referring to FIG. 27, another option is to put the portable heater system 10/portable light tower 320 itself right inside the enclosed space or building 270 (e.g. wellhead enclosure) with the exhaust plumbed/piped outside. When the portable light tower 320/portable heater system 10 is kept inside of the enclosed space or building 270, the engine 20 is easier to start, and the equipment is more secure. However, the main advantage is that by being out of the cold and wind, it is more efficient for heating. The enclosed space or building 270 may be equipped with an equipment door 480 to allow installation of the portable heater system 10/portable light tower 320. The equipment door 480 may be, for example a garage door, a roll up door, a sliding door, a barn door, or other large door or opening. If an equipment door 480 is not available, the portable heater system 10/portable light tower 320 may be sized to fit through a pedestrian door 490 or may be modular with the components sized to fit through the pedestrian door 490 when broken down or disassembled. The pedestrian door 490 may be oversized or double-wide (shown). Another option would be to temporarily open up a wall to install the portable light tower 320/portable heater system 10 and close up the wall after the installation. While illustrated in a trailer configuration 360 with an integral trailer frame or removably attached to the deck or frame of a trailer, the portable light tower 320/portable heater system 10 may be placed inside the enclosed space or building 270 without a trailer. For example, the portable light tower 320/portable heater system 10 may be small enough (or may be broken down into components that are small enough) so that it can be moved into position by two or more workers or with a crane or other lifting equipment.

The portable light tower 320/portable heater system 10 draws air for heating from inside enclosed space or building 270, to reduce the energy needed (i.e. the warm air inside the enclosed space or building 270 is recirculated through the electric resistance heater 50). Exhaust conduit 500 is used to convey exhaust from the engine 20 outside of the enclosed space or building 270 so the air inside the enclosed space or building 270 is not contaminated and the air remains breathable. Intake conduit 510 is used to provide fresh air to the engine 20 for combustion so that the oxygen in the enclosed space or building 270 is not consumed and the air remains breathable. The intake conduit 510 may also provide fresh air to the enclosed space or building 270. Out of an abundance of caution, the enclosed space or building 270 may be provided with one or more gas detectors (e.g. carbon monoxide, oxygen, carbon dioxide, nitrogen dioxide, etc.) and indicator(s) to warn a worker before entering the enclosed space or building 270 or to shut down the engine 20 or both.

In another embodiment, the portable light tower 320/portable heater system 10 may be used with or in connection with a vehicle, such as a light duty or heavy duty truck. This configuration may be useful, for example, to thaw or warm up equipment. A tarp or other covering such as a parachute may be placed over the equipment (to help trap the hot air/heat) and warm or hot air delivered from the portable light tower 320/portable heater system 10 under the tarp or other covering to thaw or warm up the equipment.

In the preceding description, for purposes of explanation, numerous details are set forth in order to provide a thorough understanding of the embodiments. However, it will be apparent to one skilled in the art that these specific details are not required. In other instances, well-known structures and components are shown in block diagram form in order not to obscure the understanding.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

What is claimed is:

1. A portable heater system comprising:
a pressurized air source, adapted to convey ambient air through an electric resistance heater comprising a plurality of heating elements, to provide heated breathable air; and
a controller adapted to control the electric resistance heater and the pressurized air source.

2. The portable heater system of claim 1, wherein the electric resistance heater includes an expansive plenum housing the plurality of heating elements, wherein air velocity is reduced through the plenum to provide increased contact time with the plurality of heating elements.

3. The portable heater system of claim 2, wherein the plenum includes a tortuous heat path across the plurality of heating elements, to provide increased contact time and to provide an increase in the eddy currents/turbulent flow to improve heat transfer to the air.

4. The portable electric resistance heater of claim 1, wherein the plurality of heating elements are set in a densely packed configuration.

5. The portable heater system of claim 2, wherein the plenum includes an obstructed heat path, the plurality of heating elements forming obstructions, to provide increased contact time and to provide an increase in the eddy currents/turbulent flow to improve heat transfer to the air.

6. The portable heater system of claim 1, wherein the plurality of heating elements are provided in several successive/sequential rows, to provide multiple stages of heating.

7. The portable heater system of claim 1, wherein an outlet flow path, from the plurality of heating elements to an outlet is smooth or direct or both to reduce pressure loss.

8. The portable heater system of claim 1, further comprising a generator, driven by an internal combustion engine, the generator adapted to power the electric resistance heater and the pressurized air source.

9. The portable heater system of claim 8, further comprising an exhaust heat recovery unit, to pre-heat the ambient air using exhaust heat from the internal combustion engine.

10. The portable heater system of claim 9, wherein the exhaust heat recovery unit comprises a heat exchanger, with exhaust on the hot side and the ambient air on the cold side.

11. The portable heater system of claim 8, further comprising a coolant heat recovery unit, to pre-heat the ambient air using coolant heat from the internal combustion engine.

12. The portable heater system of claim 11, wherein the coolant heat recovery unit comprises a heat exchanger, with engine coolant on the hot side and the ambient air on the cold side.

13. The portable heater system of claim 11, wherein the coolant heat recovery unit comprises a radiator.

14. The portable heater system of claim 13, further comprising an active louver system, having a plurality of shutters selectively moveable between an open positon where ambient airflow is generally unrestricted through the plurality of shutters and a closed position where ambient airflow is generally restricted through the plurality of shutters.

15. The portable heater system of claim 8, further comprising an enclosure, substantially enclosing at least the internal combustion engine; and an enclosure heat recovery unit, to pre-heat the ambient air using heat from the enclosure.

16. The portable heater system of claim 8, further comprising an exhaust heat recovery unit, to heat the heated breathable air using exhaust heat from the internal combustion engine, to further heat the heated breathable air.

17. The portable heater system of claim 16, wherein the exhaust heat recovery unit is a heat exchanger, with exhaust on the hot side and the heated breathable air on the cold side.

18. The portable heater system of claim 1, wherein each of the plurality of heating elements is three-phase, and the plurality of heating elements are wired in a selected wiring configuration.

19. The portable heater system of claim 18, wherein the selected wiring configuration is a delta or a Wye or a Star or in series or in series parallel.

20. The portable heater system of claim 18, wherein the selected wiring configuration is a delta configuration for the heating elements proximate an inlet end of the plenum.

21. The portable heater system of claim 18, wherein the selected wiring configuration is a wye configuration for the heating elements proximate an outlet end of the plenum.

22. The portable heater system of claim 18, wherein the selected wiring configuration is a delta configuration for the heating elements proximate an inlet end of the plenum, and wherein the selected wiring configuration is a wye configuration for the heating elements proximate an outlet end of the plenum.

23. The portable heater system of claim 8, wherein the pressurized air source is selected from the group consisting of an air blower, an air compressor, and a fan.

24. The portable heater system of claim 23, wherein the pressurized air source is an air compressor, wherein the air compressor is adapted to compress the air to pre-heat the ambient air.

25. The portable heater system of claim 1, wherein the controller comprises contact switching to control the plurality of heating elements.

26. The portable heater system of claim 1, wherein the controller comprises silicon controlled rectifier (SCR) switching or insulated-gate bipolar transistor (IGBT) switching to control the plurality of heating elements.

27. The portable heater system of claim 26, further comprising an electronics heat recovery unit, to pre-heat the ambient air using heat from one or more of the controller, IGBT switching, SCR switching, and pressurized air source drive.

28. The portable heater system of claim 27, wherein the electronics heat recovery unit comprises a ducting on enclosure adapted to route at least a portion of the ambient air through the electronics heat recovery unit.

29. The portable heater system of claim 2, further comprising a hose or conduit between the plenum and a heat user, for supplying the heated breathable air to the heat user.

30. The portable heater system of claim 29, wherein the hose or conduit is a heated hose or conduit.

31. The portable heater system of claim 30, wherein the heated hose or conduit is electrically traced or electrically heated or both.

32. The portable heater system of claim 29, further comprising a hot air wand, the hose or conduit adapted to supply the heated breathable air to the hot air wand.

33. The portable heater system of claim 29, wherein the heat user comprises a hot air distributor, wherein the hose or conduit is adapted to supply the heated breathable air to the hot air distributor to heat an enclosed space or building.

34. The portable heater system of claim 1, further comprising a utility power source connection, adapted to connect to a utility powerline supply to power the electric resistance heater, the pressurized air source, the controller, or combinations thereof.

35. The portable heater system of claim 34, wherein the utility power source is shore power.

36. The portable heater system of claim 8, further comprising a communications system adapted to provide an electronic telecommunications link between the communications system and a mobile computing device for remote reporting, remote monitoring, remote control or combinations thereof, the electronic telecommunications link comprising one or more of Wi-Fi, Bluetooth, cellular, internet, satellite, and microwave.

37. The portable heater system of claim 8, further comprising a surveillance system, the surveillance system comprising a camera system adapted to capture still images, video, or both, and a memory to store the captured images or video.

38. The portable heater system of claim 37, further comprising:
a communications system adapted to provide an electronic telecommunications link between the communications system and a mobile computing device for remote reporting, remote monitoring, remote control or combinations thereof, the electronic telecommunications link comprising one or more of Wi-Fi, Bluetooth, cellular, internet, satellite, and microwave; and
a processor for sending the captured images or video to the mobile computing device via the communications system,
wherein the remote reporting or remote monitoring comprises transmitting still images, video, or both periodically, live, real-time, near real time, or upon a triggering event.

39. The portable heater system of claim 8, further comprising a wireless receiver adapted to receive a temperature signal from a wireless temperature remote system to control the temperature proximate the wireless temperature remote system.

40. The portable heater system of claim 8, further comprising a recirculated air inlet upstream of the electric resistance heater, adapted to receive recirculated air from a heated building or enclosure or from the heated breathable air or both.

41. A portable light tower, comprising:
a mobile base;
the portable heater system of claim 8;
a mast, movable between an operating position and a transport position; and
one or more lights mounted on the mast, the generator further adapted to power the one or more lights.

42. The portable light tower of claim 41, wherein the mast is secured to the mobile base.

43. The portable light tower of claim 41, wherein the mobile base comprises a wheeled trailer, a tractor trailer, a skid, a module, or a shipping container.

44. The portable light tower of claim 41, further comprising a camera system mounted on the mast, the camera system adapted to capture still images, video, or both.

45. The portable light tower of claim 41, further comprising a communications system adapted to provide an electronic telecommunications link between the communications system and a mobile computing device for remote reporting, remote monitoring, remote control or combinations thereof, the electronic telecommunications link comprising one or more of Wi-Fi, Bluetooth, cellular, internet, satellite, and microwave.

46. The portable light tower of claim 41, further comprising a surveillance system, the surveillance system comprising a camera system adapted to capture still images, video, or both, and a memory to store the captured images or video.

47. The portable light tower of claim 46, further comprising:
a communications system adapted to provide an electronic telecommunications link between the communications system and a mobile computing device for remote reporting, remote monitoring, remote control or combinations thereof, the electronic telecommunications link comprising one or more of Wi-Fi, Bluetooth, cellular, internet, satellite, and microwave; and
a processor for sending the captured images or video to the mobile computing device via the communications system,
wherein the remote reporting or remote monitoring comprises transmitting still images, video, or both periodically, live, real-time, near real time, or upon a triggering event.

48. The portable light tower of claim 41, further comprising a wireless receiver adapted to receive a temperature signal from a wireless temperature remote system to control the temperature proximate the wireless temperature remote system.

49. The portable light tower of claim 41, wherein the generator comprises a multi-voltage genset and transformers to provide between two and four different voltages at one time.

50. The portable light tower of claim 41, further comprising a recirculated air inlet, upstream of the electric resistance heater, adapted to receive recirculated air from a heated building or enclosure or from the heated breathable air or both.

51. The portable light tower of claim 41, wherein the one or more lights comprise light emitting diode (LED) lights.

52. The portable light tower of claim 51, wherein the LED lights operate on 208 volts or 230 volts.

53. A portable heater system for a light tower having a generator driven by an internal combustion engine, comprising:
an electric resistance heater, adapted to connect to the generator;
a pressurized air source, adapted to connect to the generator and convey ambient air through the electric resistance heater, to provide heated breathable air,
wherein the generator is adapted to power the electric resistance heater and the pressurized air source; and
a controller adapted to control the electric resistance heater and the pressurized air source.

54. The portable heater system of claim 53, further comprising:
an exhaust heat recovery unit, adapted to pre-heat the ambient air using exhaust heat from the internal combustion engine; and
an engine exhaust coupling, adapted to connect the exhaust heat recovery unit to the internal combustion engine.

55. The portable heater system of claim 53, further comprising:
a coolant heat recovery unit, adapted to pre-heat the ambient air using coolant heat from the internal combustion engine; and
an engine coolant coupling, adapted to connect the coolant heat recovery unit to the internal combustion engine.

56. The portable heater system of claim 53, wherein the light tower comprises an enclosure substantially enclosing at least the internal combustion engine, the portable heater system further comprising:
an enclosure heat recovery unit, adapted to pre-heat the ambient air using heat from the enclosure; and
an enclosure coupling, adapted to connect the enclosure heat recovery unit to the enclosure.

57. The portable heater system of claim 53, further comprising an electronics heat recovery unit, adapted to pre-heat the ambient air using heat from one or more of the controller, IGBT switching, SCR switching, and blower motor.

58. The portable heater system of claim 57, wherein the electronics heat recovery unit comprises a ducting or enclosure adapted to route at least a portion of the ambient air through or across the electronics heat recovery unit.

59. The portable heater system of claim 57, further comprising a recirculated air inlet, upstream of the electric resistance heater, adapted to receive recirculated air from a heated building or enclosure or from the heated breathable air or both.

60. A method of operating the portable heater system of claim 8, the portable light tower of claim 41, or the portable heater system of claim 53, comprising:
setting a mode of operation, the mode of operation selected from the group of:
a normal mode of operation, and controlling the electric resistance heater and the pressurized air source in response to a local user selectable setting for the electric resistance heater or the pressurized air source or both; and
a stand-by or shut down for night (SDFN) mode of operation, and controlling the electric heater and the pressurized air source in a stand-by mode.

61. The method of claim 60, the group further comprising:
an adaptive mode of operation, and controlling the electric heater and the pressurized air source to automatically phase back the electric heater to make power available to an auxiliary load when the auxiliary load is added, and ramp up the electric heater when the auxiliary load is removed.

62. The method of claim 61, wherein the auxiliary load is a well site shack or other electrical load.

63. The method of claim 60, the group further comprising:
a one hundred degree plus rise mode of operation, and controlling the electric heater and the pressurized air source to automatically provide a temperature rise of about 100° F. plus;
a safety mode of operation, and controlling the electric heater and the pressurized air source to automatically limit the heated air temperature to a maximum of about 212° F.;
a no burn mode of operation, and controlling the electric heater and the pressurized air source to automatically limit the heated air temperature to a maximum of about 220° F.;
a hazardous location mode of operation, and controlling the electric heater and the pressurized air source to automatically limit the heated air temperature to a maximum of about 392° F.; and
a high heat mode of operation, and controlling the electric heater and the pressurized air source to automatically limit the heated air temperature to a maximum of about 1000° F.; a maximum heat mode of operation, and controlling the electric heater and the pressurized air source to automatically limit the heated air to a maximum of about 1600° F.

64. The method of claim 63, wherein in the hazardous location mode of operation, the maximum heated air temperature reduced to take into account the heat soak of the electric heater, such that even in the event of the loss of the pressurized air source, the temperature would not exceed 392° F.

65. The method of claim 60, the group further comprising a remote mode of operation, and controlling the electric heater and the pressurized air source in response to a remote user setting for the electric heater or the pressurized air source or both.

66. The method of claim 65, wherein the remote user setting is provided via an electronic telecommunications link, adapted to provide for remote monitoring, remote reporting, remote control or combinations thereof, the electronic telecommunications link comprising one or more of Wi-Fi, Bluetooth, cellular, internet, microwave and satellite.

67. The method of claim 60, further comprising:
providing a wireless temperature remote system and an associated receiver, adapted to measure the temperature at a remote location which is received at the receiver; and
the group further comprising a remote set temperature mode, wherein the electric heater and the pressurized air source are operated to maintain the temperature at the remote location.

68. The method of claim 60, further comprising directing the heated breathable air to an at least partially enclosed space or building.

69. The method of claim 68, wherein the at least partially enclosed space or building is a high rise building while under construction.

70. The method of claim 69, further comprising tying the portable heater system or the portable light tower into building duct work.

71. The method of claim 68, further comprising recirculating at least a portion of the air from the at least partially enclosed space or building to the electric resistance heater.

72. The method of claim 68, wherein the at least partially enclosed space or building is a wellhead enclosure.

73. The method of claim 68, wherein the at least partially enclosed space or building is an environmentally controlled workspace.

74. The method of claim 73, further comprising conducting a workspace activity once the environmentally controlled workspace reaches a predetermined temperature.

75. The method of claim 74, wherein the workspace activity is maintaining at least the predetermined temperature to allow stucco or concrete to cure.

76. The method of claim 68, wherein the at least partially enclosed space or building is the interior of a segment of pipeline.

77. The method of claim 76, further comprising conducting a pipeline activity once the segment of pipeline reaches a predetermined temperature.

78. The method of claim 77, the pipeline activity selected from the group of warming, drying, sandblasting, coating/painting, fabrication, bending, welding, moving, and expansion or growth testing.

79. The method of claim 68, wherein the at least partially enclosed space or building is the interior of a storage or process tank or vessel.

80. The method of claim 79, further comprising conducting a tank or vessel activity once the tank or vessel reaches a predetermined temperature.

81. The method of claim 80, the tank or vessel activity selected from the group of warming, drying, sandblasting, coating/painting, bending, and welding.

82. The method of claim 60, further comprising locating the portable heater system, the portable light tower, or the portable heater system inside an at least partially enclosed space or building, and piping or plumbing exhaust from the engine outside of the at least partially enclosed space or building.

83. The method of claim 82, wherein the portable heater system or the portable light tower comprises a sound proof enclosure substantially enclosing at least the internal combustion engine.

84. The method of claim 60, wherein the portable heater system or the portable light tower comprise a coolant heat recovery unit, to pre-heat the ambient air using coolant heat from the internal combustion engine, wherein the coolant heat recovery unit comprises a radiator, the method further comprising, responsive to activation of the electric resistance heater, selectively moving a plurality of air flow shutters between an open positon wherein ambient airflow is generally unrestricted through the radiator when the electric resistance heater is off and a closed position wherein ambient airflow is generally restricted through the radiator when the electric resistance heater is on.
